(19) United States
(12) Patent Application Publication
(10) Pub. No.: US 2025/0244978 A1
(43) Pub. Date: Jul. 31, 2025

(54) TECHNIQUES FOR CONVERTING SQL DIALECT APPLICATION PROGRAMS TO DATAFLOW GRAPHS

(71) Applicant: Ab Initio Technology LLC, Lexington, MA (US)

(72) Inventors: Kevin Bradshaw, Hollis, NH (US); Jared Smythe, Cary, NC (US); Marshall Isman, Newton, MA (US)

(73) Assignee: Ab Initio Technology LLC, Lexington, MA (US)

(21) Appl. No.: 19/039,118

(22) Filed: Jan. 28, 2025

Related U.S. Application Data
(60) Provisional application No. 63/667,510, filed on Jul. 3, 2024.
(60) Provisional application No. 63/627,584, filed on Jan. 31, 2024.

(51) Int. Cl. G06F 8/41

(52) U.S. Cl. CPC G06F 8/433

(57) ABSTRACT

Techniques for converting application programs written in a source structured query language (SQL) dialect to respective computer programs embodied by dataflow graphs, the method comprising using at least one computer hardware processor to perform: obtaining a source SQL dialect (SSD) application program comprising one or more SSD scripts, the one or more SSD scripts comprising a plurality of SSD statements; translating the plurality of SSD statements into a respective plurality of target SQL dialect (TSD) statements; converting the plurality of TSD statements into a respective plurality of dataflow graphs; and merging dataflow graphs in the plurality of dataflow graphs to obtain one or more merged dataflow graphs.

### CROSS-REFERENCE TO RELATED APPLICATIONS

This application claims the benefit of priority to U.S. Provisional Application No.: 63/667,510, titled “TECHNIQUES FOR CONVERTING SQL DIALECT APPLICATION PROGRAMS TO DATAFLOW GRAPHS”, filed on Jul. 3, 2024, and U.S. Provisional Application No.: 63/627,584, titled “TECHNIQUES FOR CONVERTING SQL DIALECT APPLICATION PROGRAMS TO DATAFLOW GRAPHS”, filed on Jan. 31, 2024, each of which is herein incorporated by reference in its entirety.

### FIELD

Aspects of the present disclosure relate to techniques for converting application programs written in a source structured query language (SQL) dialect to respective computer programs embodied by dataflow graphs.

### BACKGROUND

A data processing system may use one or more computer programs to process data. One or more of the computer programs utilized by the data processing system may be developed as executable dataflow graphs. An executable dataflow graph may include components, termed “nodes” or “vertices,” specifying executable code for data processing operations to be performed on input data. An executable dataflow graph may further include edges or links between the components representing flows of data. Nodes of a dataflow graph may include one or more input nodes representing respective input datasets, one or more output nodes representing respective output datasets, and one or more nodes representing data processing operations to be performed on data. Techniques for executing computations encoded by dataflow graphs are described in U.S. Pat. No. 5,966,072, titled “Executing Computations Expressed as Graphs,” and in U.S. Pat. No. 7,716,630, titled “Managing Parameters for Graph-Based Computations,” each of which is incorporated by reference herein in its entirety.

### SUMMARY

Some embodiments provide for a method for converting application programs written in a source structured query language (SQL) dialect to respective computer programs embodied by dataflow graphs, the method comprising using at least one computer hardware processor to perform: obtaining a source SQL dialect (SSD) application program comprising one or more SSD scripts, the one or more SSD scripts comprising a plurality of SSD statements; translating the plurality of SSD statements into a respective plurality of target SQL dialect (TSD) statements; converting the plurality of TSD statements into a respective plurality of dataflow graphs; and merging dataflow graphs in the plurality of dataflow graphs to obtain one or more merged dataflow graphs.

Some embodiments provide for a system for converting application programs written in a source structured query language (SQL) dialect to respective computer programs embodied by dataflow graphs, the system comprising: at least one computer hardware processor; at least one non-transitory computer-readable storage medium storing processor-executable instructions that, when executed by the at least one computer hardware processor, causes the at least one computer hardware processor to perform: obtaining a source SQL dialect (SSD) application program comprising one or more SSD scripts, the one or more SSD scripts comprising a plurality of SSD statements; translating the plurality of SSD statements into a respective plurality of target SQL dialect (TSD) statements; converting the plurality of TSD statements into a respective plurality of dataflow graphs; and merging dataflow graphs in the plurality of dataflow graphs to obtain one or more merged dataflow graphs.

Some embodiments provide for at least one non-transitory computer-readable storage medium storing processor-executable instructions that, when executed by at least one computer hardware processor, causes the at least one computer hardware processor to perform a method for converting application programs written in a source structured query language (SQL) dialect to respective computer programs embodied by dataflow graphs, the method comprising: obtaining a source SQL dialect (SSD) application program comprising one or more SSD scripts, the one or more SSD scripts comprising a plurality of SSD statements; translating the plurality of SSD statements into a respective plurality of target SQL dialect (TSD) statements; converting the plurality of TSD statements into a respective plurality of dataflow graphs; and merging dataflow graphs in the plurality of dataflow graphs to obtain one or more merged dataflow graphs.

Some embodiments provide for a method for converting application programs written in a source structured query language (SQL) dialect to respective computer programs embodied by dataflow graphs, the method comprising: at least one computer hardware processor; a least one non-transitory computer-readable storage medium storing processor-executable instructions that, when executed by the at least one computer hardware processor, causes the at least one computer hardware processor to perform: obtaining a source SQL dialect (SSD) application program comprising one or more SSD scripts, the one or more SSD scripts comprising a plurality of SSD statements; translating the plurality of SSD statements into a respective plurality of target SQL dialect (TSD) statements; converting the plurality of TSD statements into a respective plurality of dataflow graphs; and executing the respective plurality of dataflow graphs.

Some embodiments provide for system comprising: at least one computer hardware processor; and at least one non-transitory computer-readable storage medium storing processor-executable instructions that, when executed by the at least one computer hardware processor, causes the at least one computer hardware processor to perform a method for converting application programs written in a source structured query language (SQL) dialect to respective computer programs embodied by dataflow graphs, the method comprising: obtaining a source SQL dialect (SSD) application program comprising one or more SSD scripts, the one or more SSD scripts comprising a plurality of SSD statements; translating the plurality of SSD statements into a respective plurality of target SQL dialect (TSD) statements; converting the plurality of TSD statements into a respective plurality of dataflow graphs; and executing the respective plurality of dataflow graphs.

Some embodiments provide for at least one non-transitory computer-readable storage medium storing processor-executable instructions that, when executed by at least one computer hardware processor, causes the at least one computer hardware processor to perform a method for converting application programs written in a source structured query language (SQL) dialect to respective computer programs embodied by dataflow graphs, the method comprising: obtaining a source SQL dialect (SSD) application program comprising one or more SSD scripts, the one or more SSD scripts comprising a plurality of SSD statements; translating the plurality of SSD statements into a respective plurality of target SQL dialect (TSD) statements; converting the plurality of TSD statements into a respective plurality of dataflow graphs; and executing the respective plurality of dataflow graphs.

Some embodiments provide for a method for executing a computer program embodied by a plurality of dataflow graphs, the method comprising using at least one computer hardware processor to perform obtaining a plurality of dataflow graphs representing different portions of the computer program, each of the plurality of graphs configured to read at least one input dataset and configured to write at least one output dataset; merging dataflow graphs in the plurality of dataflow graphs to obtain one or more merged dataflow graphs; and executing the one or more merged dataflow graphs.

Some embodiments provide for a system for executing of a computer program embodied by a plurality of dataflow graphs, the system comprising at least one computer hardware processor; and at least one non-transitory computer readable storage medium storing processor executable instructions that, when executed by the at least one computer hardware processor, cause the at least one computer hardware processor to perform: obtaining a plurality of dataflow graphs representing different portions of the computer program, each of the plurality of graphs configured to read at least one input dataset and configured to write at least one output dataset; merging dataflow graphs in the plurality of dataflow graphs to obtain one or more merged dataflow graphs; and executing the one or more merged dataflow graphs.

Some embodiments provide for at least one non-transitory computer readable storage medium storing processor executable instructions that, when executed by at least one computer hardware processor, cause the at least one computer hardware processor to perform: obtaining a plurality of dataflow graphs representing different portions of the computer program, each of the plurality of graphs configured to read at least one input dataset and configured to write at least one output dataset; merging dataflow graphs in the plurality of dataflow graphs to obtain one or more merged dataflow graphs; and executing the one or more merged dataflow graphs.

The foregoing summary is non-limiting.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A-1B illustrate challenges faced in migrating data and applications between different data processing environments.

FIG. 1C is a block diagram illustrating conversion of an application program written in Hive Query Language (HQL) to a computer program embodied by one or more dataflow graphs, in accordance with some embodiments of the technology described herein.

FIG. 2A is another block diagram illustrating conversion of an application program written in Hive Query Language (HQL) to a computer program embodied by one or more dataflow graphs, in accordance with some embodiments of the technology described herein.

FIG. 2B is a block diagram illustrating conversion of an application program written in a source structured query language (SQL) dialect to a computer program embodied by one or multiple dataflow graphs, in accordance with some embodiments of the technology described herein.

FIG. 3A is a schematic diagram illustrating conversion of an application program written in HQL into a graph application program, with multiple HQL scripts and HQL script orchestration logic of the application program being converted to multiple dataflow graphs and a control flow plan corresponding to the HQL script orchestration logic, in accordance with some embodiments of the technology described herein.

FIG. 3B is a schematic diagram illustrating conversion of an application program written in a source SQL dialect into a graph application program, with multiple source SQL dialect scripts and source SQL dialect script orchestration logic of the application program being converted to multiple dataflow graphs and a control flow plan corresponding to the source SQL dialect script orchestration logic, in accordance with some embodiments of the technology described herein.

FIG. 3C is a schematic diagram illustrating conversion of an application program written in HQL into a graph application program, with multiple HQL scripts and HQL script orchestration logic of the application program being converted to a smaller number of merged dataflow graphs and a control flow plan corresponding to the HQL script orchestration logic, in accordance with some embodiments of the technology described herein.

FIG. 4A illustrates a data processing system for converting an application program written in a source SQL dialect and configured to execute in a source SQL dialect environment into a computer program embodied by one or more dataflow graphs and executing the resulting computer program, in accordance with some embodiments of the technology described herein.

FIG. 4B illustrates a data processing system for executing a computer program comprising one or more dataflow graph(s) obtained by converting application programs written in a source SQL dialect and configured to execute in a source SQL dialect environment into the dataflow graph(s) and executing the resulting computer program, in accordance with some embodiments of the technology described herein.

FIG. 4C illustrates a data processing system for converting an application program written in HQL and configured to execute in a Hadoop cluster into a computer program embodied by one or more dataflow graphs and executing the resulting computer program, in accordance with some embodiments of the technology described herein.

FIG. 5A is a flowchart of an illustrative process for converting an application program written in a source SQL dialect into a respective computer program embodied by one or more dataflow graphs and executing the respective computer program, in accordance with some embodiments of the technology described herein.

FIG. 5B is a flowchart of an illustrative process for translating source SQL dialect (SSD) statements into corresponding target SQL dialect (TSD) statements, in accordance with some embodiments of the technology described herein.

FIG. 5C is a block diagram of an example data processing system for converting application programs written in a source SQL dialect and configured to execute in a source SQL dialect environment into respective computer programs, each embodied by one or multiple dataflow graphs, and executing the resulting computer programs, in accordance with some embodiments of the technology described herein.

FIGS. 6A-6C show illustrative dataflow graphs each being obtained from a respective target SQL dialect statement, in accordance with some embodiments of the technology described herein.

FIG. 6D shows an illustrative merged dataflow graph obtained by merging the illustrative dataflow graphs shown in FIG. 6A-6C, in accordance with some embodiments of the technology described herein.

FIG. 7A shows a portion of a HQL dialect script part of an HQL application, in accordance with some embodiments of the technology described herein.

FIG. 7B shows a portion of a PostgreSQL script obtained by translating the HQL dialect script shown in FIG. 7A, in accordance with some embodiments of the technology described herein.

FIGS. 8A and 8B show illustrative dataflow graphs each obtained from a respective target SQL dialect script, in accordance with some embodiments of the technology described herein.

FIG. 8C shows an illustrative merged dataflow graph obtained by merging the illustrative dataflow graphs shown in FIGS. 8A and 8B, in accordance with some embodiments of the technology described herein.

FIG. 9 shows an illustrative dataflow graph generated from an SSD application program that reads from a data source multiple times, according to some embodiments of the technology described herein.

FIG. 10 shows an example dataflow graph generated from an SSD application program in which a data source is a partitioned data source, according to some embodiments of the technology described herein.

FIG. 11 is a block diagram of an illustrative computing system that may be used in implementing some embodiments of the technology described herein.

### DETAILED DESCRIPTION

Application programs written in conventional database system environments are large, difficult to maintain, and computationally inefficient. Yet such applications often form the backbone of enterprise level systems in multiple companies, run at a high frequency (e.g., daily), and implement mission-critical processes. Although it is desirable to migrate such application programs (as well as data they access) to a cloud computing environment, or some other modern data processing system environment, and/or to optimize the execution of such application programs, it is a difficult and time-consuming task. For select application programs such a migration can—perhaps—be done manually by programmers, but such migration often takes multiple months if not longer to execute, requires subsequent complex and intensive quality assurance processes to ensure that the migration did not introduce errors, and even if an enterprise can afford to pay for such a process in select cases, the approach does not scale and cannot address the sheer number of application programs already deployed by enterprises across different types of database environments.

As an example, an enterprise database environment may be a Hadoop environment within which multiple Hive Query Language (HQL) application programs are deployed. An HQL application program may comprise hundreds or thousands or tens of thousands HQL statements (which may organized into scripts, of which there may be tens or hundreds, for example). Porting such an application program to a cloud computing environment (e.g., AWS, Azure, GCP, etc.) is a substantial task, requiring much computational resources as well as time and energy from developers who are most likely not the original authors of the HQL application and, therefore, are unfamiliar with it. And there can be tens, hundreds, or thousands of such applications. Additionally, there are many types of database environments (e.g., IBM DB2, Apache Spark, TERADATA, SNOWFLAKE, BIGQUERY, etc.) and there are numerous applications built in such database environments. Migrating such applications, regardless of the original database environment, to another target environment and, in the process potentially optimizing their execution, is a difficult computational task.

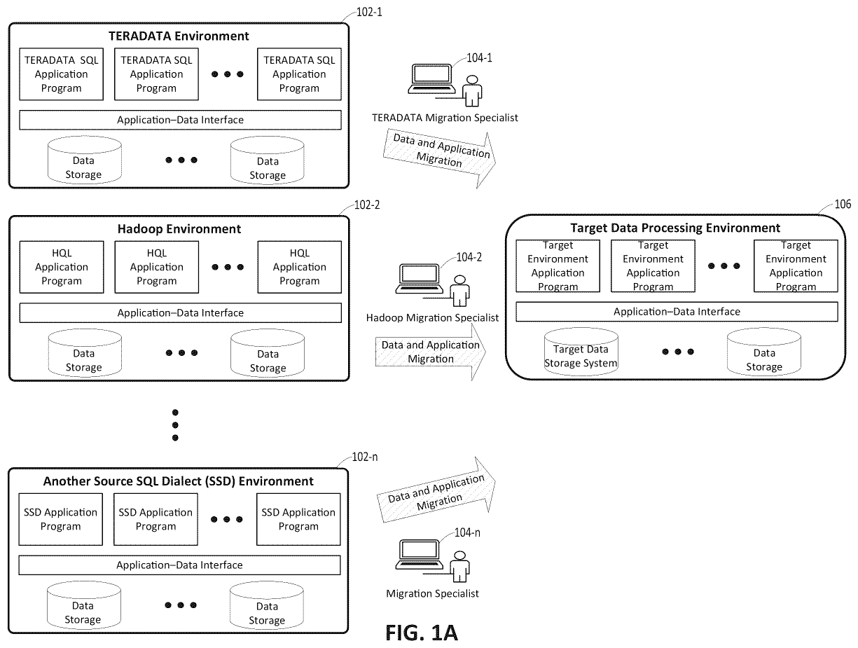

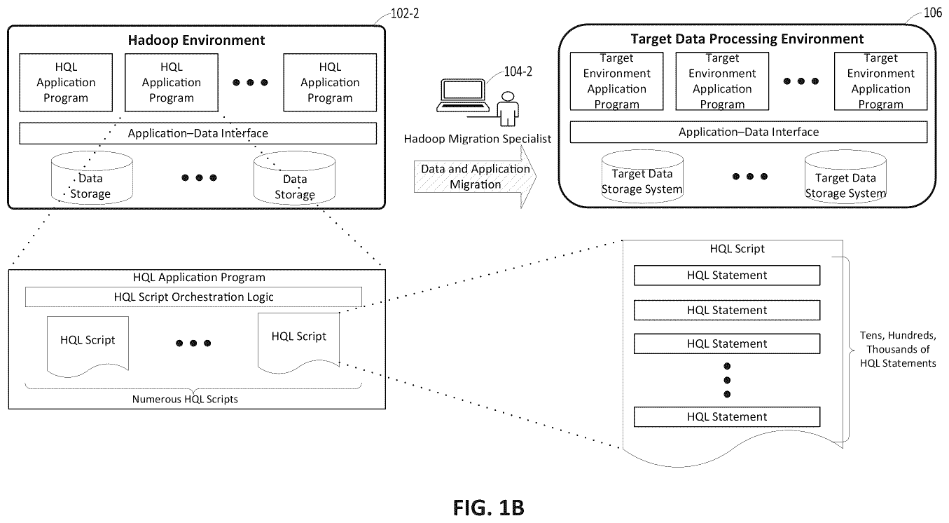

FIGS. 1A and 1B illustrate some of these challenges. As shown in FIG. 1A, data and application migration may be of interest in a number of settings. For example, it may be desirable to migrate one more application programs and/or data from a variety of different computing environments (e.g., a conventional database management system environment, a non-computing environment, environments 102-1, 102-2, . . . 102-n, etc.) to a different computing environment (e.g., a different database management system, a cloud-based environment, target data processing environment 106, etc.). As shown in the example of FIG. 1A, an enterprise may have various application programs and associated data in a variety of computing environments, such as TERADATA environment 102-1, Hadoop environment 102-2, and one or more other environments such as environment 102-n. The application programs in these environments may be written in different languages. For example, application programs in TERADATA environment 102-1 may be written in TERADATA SQL and application programs in the Hadoop environment 102-2 may be written in HQL. Application programs in other computing environments (examples of which are provided herein) may be written in yet other SQL dialects or other languages. Thus, application and data migrations present with the challenge of migrating applications and data from different types of source environments to one or more target environments, and the situation may be that the ways in which the data to be migrated is stored and the applications to be migrated are written are customized to their source environment, whereas ways in which the data is to be stored and the language in which the target applications are to be written in the target environment is to be customized to the target environment instead. This complexity typically results in involving substantial manual effort in migration and utilization of different specialists in migrating from different environments (e.g., migration specialists 104-1, 104-2, 104-n). However, as described above, such effort takes a long time, requires time-consume and expensive verification and maintenance, and simply does not scale with the sheer number of application programs that have be migrated.

Indeed, as shown in FIG. 1B for the Hadoop environment 102-2, a single HQL application program can include have numerous (e.g., tens, hundreds) HQL scripts, while each such HQL script may include numerous (e.g., tends, hundreds, or thousands) of HQL statements. The fact that any migration is likely to involve multiple such HQL application programs only further brings the difficulty and complexity of the migration task into focus.

The inventors have developed techniques for migrating application programs written in conventional database environments (e.g., database management systems) to corresponding computer programs embodied in dataflow graphs that can execute in any suitable data processing system (e.g., as part of a cloud computing environment or any other suitable computing environment). The techniques involve automatically converting an application program written in a source SQL dialect (examples of which are provided herein) to a computer program embodied in one or multiple dataflow graphs. In some embodiments, as part of the conversion, each of the source SQL dialect statements is converted to a respective dataflow graph. The dataflow graphs may then be optimized and executed in a data processing system that executes dataflow graphs. The resulting dataflow graphs can be executed in any suitable computing environment and may be optimized prior to execution such that the collection of optimized dataflow graphs (embodying the functionality of the original application program being migrated from a conventional database environment) executes much more quickly (higher throughput, increased parallelism, etc.) than the original application program and, because data processing systems executing dataflow graphs can operate in any of numerous types of environments, then so can the dataflow graphs embodying the original application program. Thus, an application program may be automatically converted to multiple dataflow graphs and be executed in a cloud computing environment, for example. By converting (e.g., using software embodied in conversion logic 108, which may implement the technology described herein) the application program (e.g., HQL scripts 110 and 112 part of HQL application program 109) to one or more dataflow graphs (e.g., dataflow graphs 114 and 116 part of graph application program 111) using techniques described herein, the migration of the application program to another computing environment can be achieved in a scalable and computationally efficient manner. The migration is also more reliable (less error-prone). Additionally, migration can also be performed more efficiently than with conventional techniques (e.g., using less time and less computing resources required).

Moreover, in some embodiments, the dataflow graphs derived from SQL dialect statements in an application program written source SQL dialect can be merged into one or multiple merged dataflow graphs. Thus, for example, the entire original application being migrated may be converted to a single merged dataflow graph (or a small number of merged dataflow graphs, which is smaller than the number of source SQL dialect statements). As one specific example, an application program having thousands of SNOWFLAKE SQL statements spread across numerous (e.g., tens of) files can be converted to a single merged dataflow graph (or a small number or merged dataflow graphs). In turn, the merged dataflow graph(s) may be further optimized, as described herein, to substantially improve the computational efficiency with which the converted version of the original application program executes. Such merging and optimizations, for example, eliminate unnecessary (and quite computationally expensive) reads and writes of datasets, provide pipeline parallelism, and take advantage of a global optimization across the entire application program rather than only allowing for local optimization of individual source SQL dialect statements. Such techniques and their variations are described herein.

Some embodiments provide for a method for converting application programs written in a source structured query language (SQL) dialect to respective computer programs embodied by dataflow graphs, the method comprising: (A) obtaining a source SQL dialect (SSD) application program comprising one or more SSD scripts (e.g., a SNOWFLAKE SQL script OR HQL script), the one or more SSD scripts comprising a plurality of SSD statements (e.g., multiple SNOWFLAKE SQL statements or multiple HQL statements); (B) translating the plurality of SSD statements into a respective plurality of target SQL dialect (TSD) statements (e.g., multiple ANSI-92 SQL statements or multiple PostgreSQL statements); (C) converting the plurality of TSD statements into a respective plurality of dataflow graphs (e.g. one or more such dataflow graphs per TSD statement); and (D) merging dataflow graphs in the plurality of dataflow graphs to obtain one or more merged dataflow graphs.

When the SSD application program includes multiple SSD scripts, the translation and conversion steps may be repeated for all of the statements in the multiple SSD scripts to obtain dataflow graphs from the SSD statements in the multiple scripts. Subsequently, the obtained dataflow graphs may be merged into a single merged dataflow graph (e.g., one merged dataflow graph representing the entire SSD application program) or multiple merged dataflow graphs (e.g., one merged data dataflow graph per SSD script or for a collection of SSD statements across one or multiple scripts).

Accordingly, in some embodiments, the one or more SSD scripts include a first SSD script and a second SSD script, the plurality of SSD statements includes a first plurality of SSD statements in the first SSD script and a second plurality of SSD statements in the second SSD script, translating the plurality of SSD statements comprises: (1) translating the first plurality of SSD statements into a first plurality of TSD statements in the plurality of TSD statements, and (2) translating the second plurality of SSD statements to a second plurality of TSD statements in the plurality of TSD statements; and converting the plurality of TSD statements comprises: (1) converting the first plurality of TSD statements into a first plurality of dataflow graphs in the plurality of dataflow graphs, and (2) converting the second plurality of TSD statements into a second plurality of dataflow graphs in the plurality of dataflow graphs.

In turn, merging dataflow graphs in the plurality of dataflow graphs may comprise: merging the first plurality of dataflow graphs and the second plurality of dataflow graphs into a single merged dataflow graph (e.g., representing the SSD application program). Alternatively, merging dataflow graphs in the plurality of dataflow graphs may comprises: (1) merging the first plurality of dataflow graphs into a first merged dataflow graph, and (2) merging the second plurality of dataflow graphs into a second merged dataflow different from the first merged dataflow graph. The first and second merged dataflow graphs may represent different SSD scripts or other groups of SSD statements.

In some instances, the SSD application may include multiple (e.g., 2 or more) SSD scripts. In some embodiments, the one or more SSD scripts include multiple SSD scripts, the plurality of SSD statements includes a respective set of SSD statements in each of the multiple SSD scripts, translating the plurality of SSD statements comprises translating each of the respective sets of SSD statements into respective sets of TSD statements in the plurality of TSD statements, and converting the plurality of TSD statements comprises converting each of the respective sets of TSD statements into a respective set of dataflow graphs in the plurality of dataflow graphs.

In some embodiments, merging dataflow graphs in the plurality of dataflow graphs may involve merging dataflow graphs across multiple or all of the respective sets of dataflow graphs into a single merged dataflow graph. Alternatively, merging dataflow graphs in the plurality of dataflow graphs may involve merging dataflow graphs in each of the respective sets of dataflow graphs into a respective merged dataflow graph thereby obtaining a plurality of merged dataflow graphs.

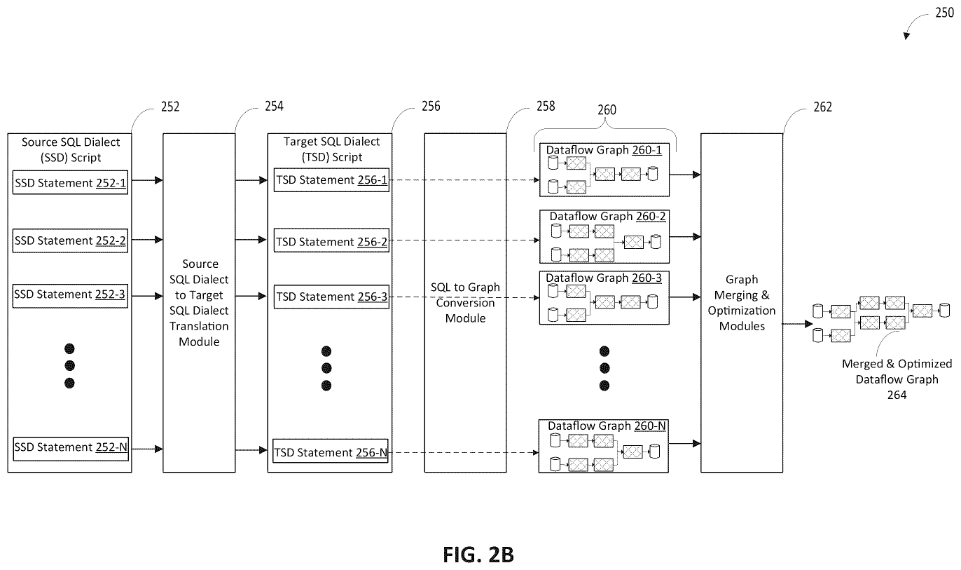

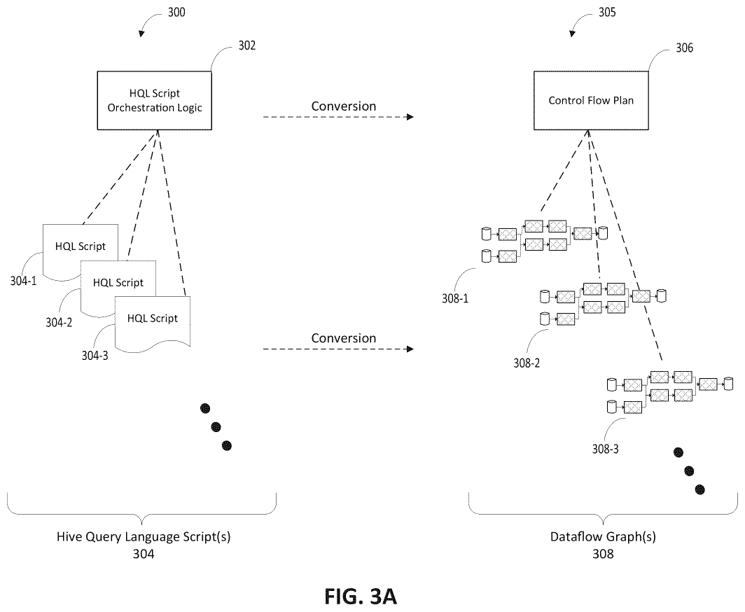

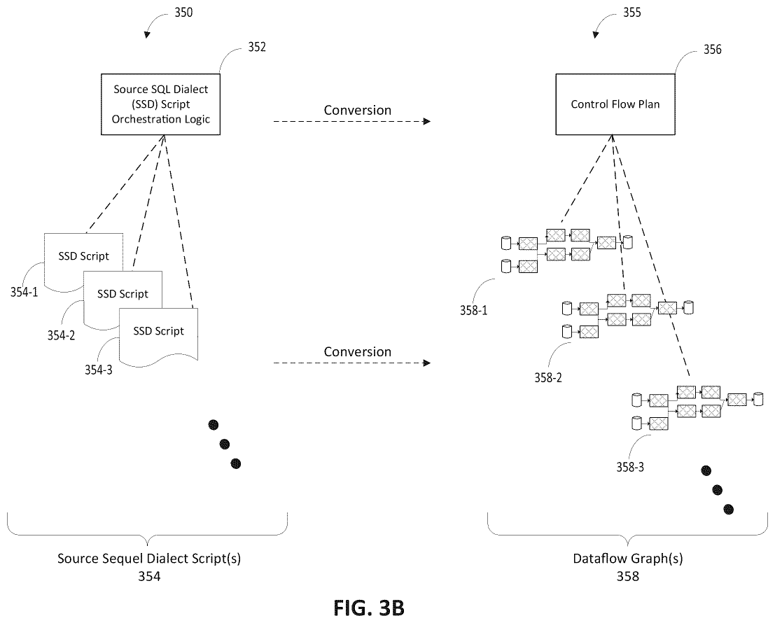

In some embodiments in which the SSD (e.g., HQL) application program includes multiple SSD scripts (e.g., multiple HQL scripts), the SSD application program may also include orchestration logic that controls the sequence in which the multiple SSD scripts execute. Order of execution may be important, for example because the processing performed by one SSD script depends on calculations and/or actions performed by another SSD script or scripts. As such, executing the orchestration logic may cause the multiple SSD scripts to execute in a designed and specified sequence. Consequently, in the embodiments where multiple SSD scripts are converted to multiple merged dataflow graphs, software may be needed to control the sequence in which the multiple merged dataflow graphs execute. Accordingly, in some embodiments, the SSD script orchestration logic may be converted to a respective control flow plan (e.g., a control flow graph) for orchestrating execution of the multiple merged dataflow graphs (because their execution may need to be sequenced). This is further described herein, including with respect to FIGS. 3A and 3B.

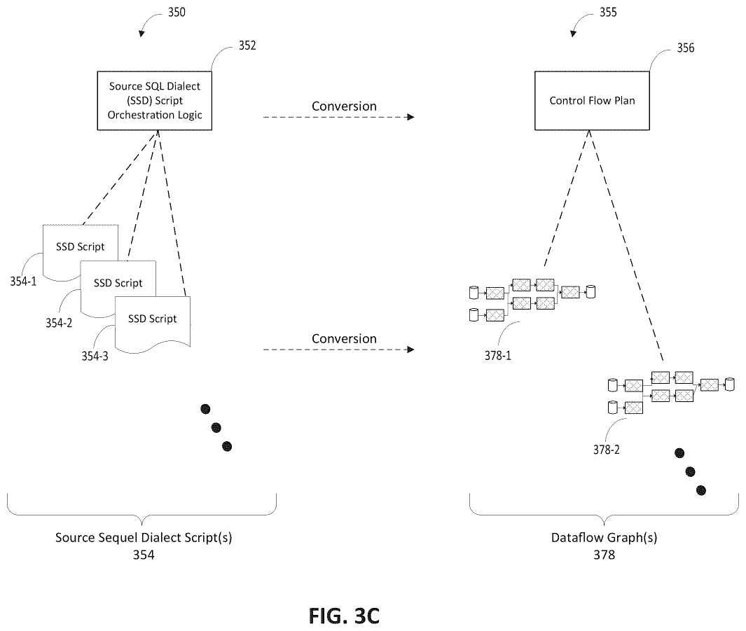

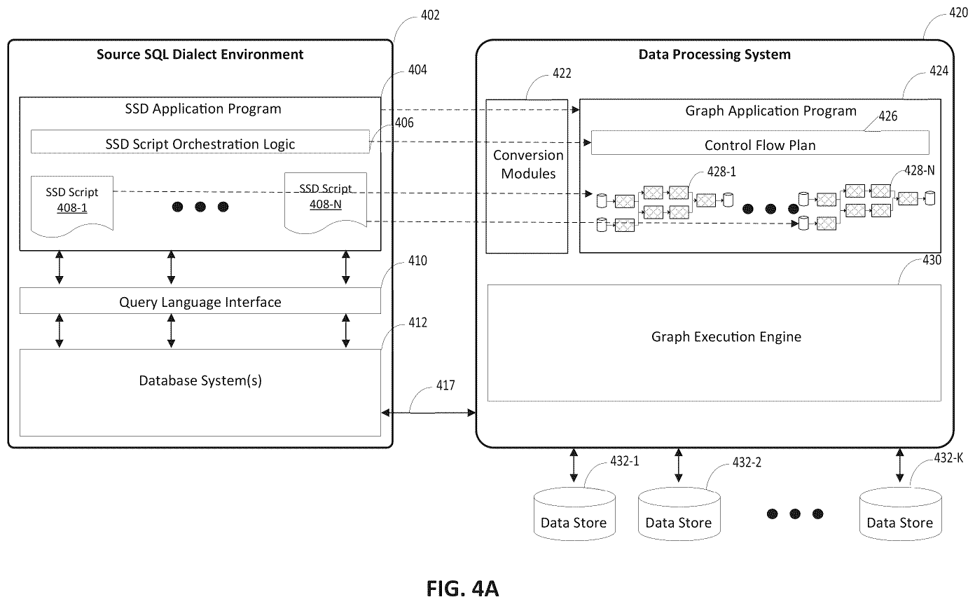

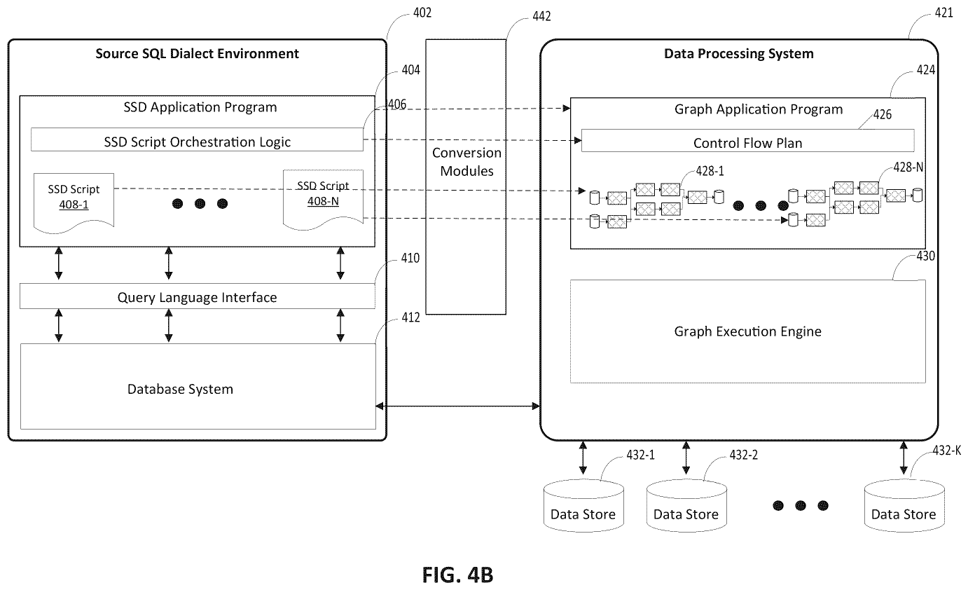

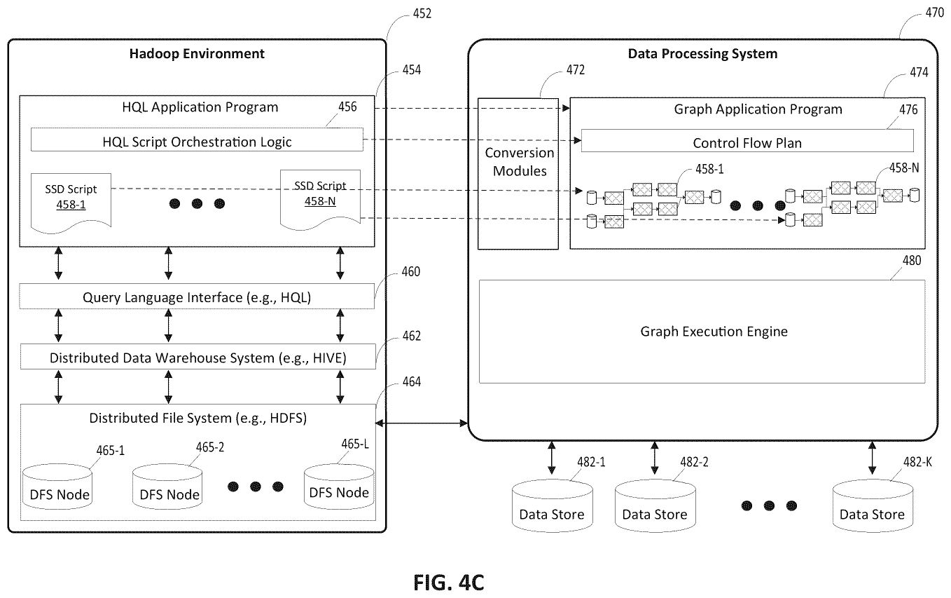

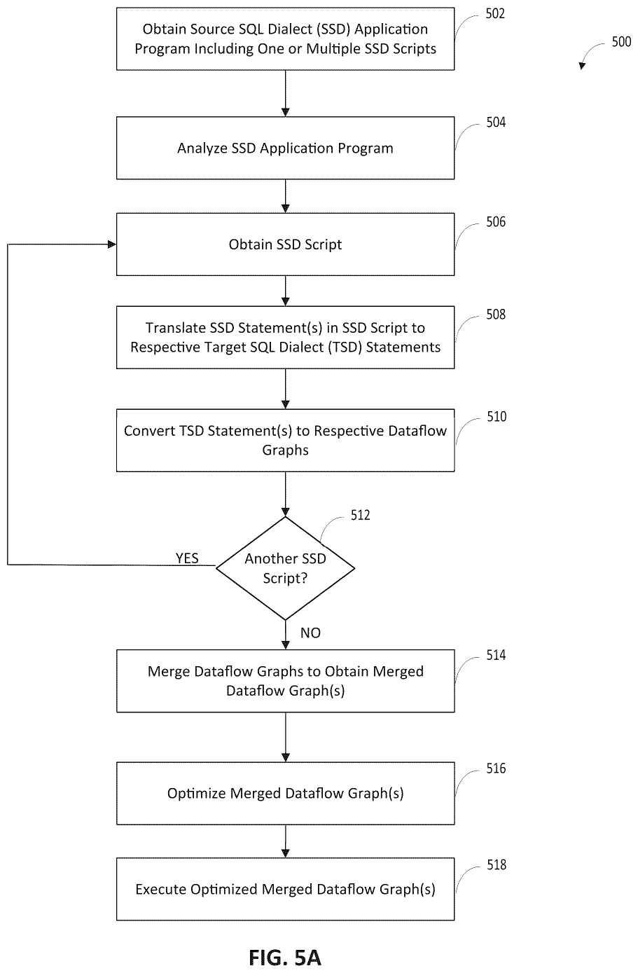

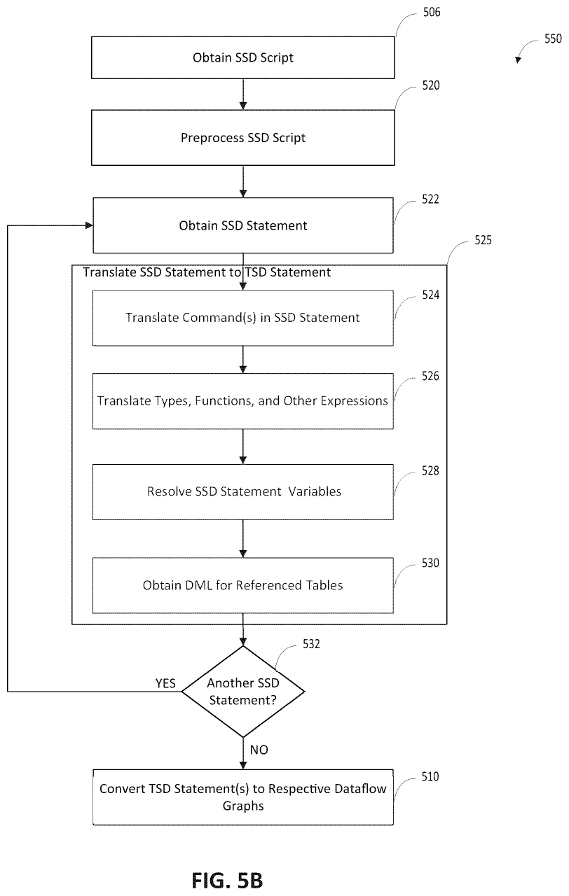

Once the one or more merged dataflow graphs are obtained by merging the dataflow graphs in the plurality of dataflow graphs, the merged dataflow graph(s) may be executed (e.g., using a graph execution engine, such as graph execution engine 430, 480, or 580 shown in FIGS. 4A-4C and 5C). Prior to execution, processing layouts may be assigned to nodes in the merged dataflow graph, whereby a processing layout for a node indicating the number of processors (and which processor(s)) are to perform the data processing operation represented by the node. In some embodiments, the same layouts may be assigned to the nodes (e.g., the same number of processors). Thus, each node would have a layout having the same degree of parallelism (e.g., serial, N-way parallel, etc.). However, in some embodiments, different nodes may have processing layouts with different degrees of parallelism. Aspects of assigning processing layouts to nodes with different degrees of parallelism are described in U.S. Pat. No. 10,817,495, filed on Mar. 29, 2018, titled “Systems and Methods for Performing Data Processing Operations Using Variable Level Parallelism,” which is incorporated by reference herein in its entirety.

In some embodiments, prior to being executed, the merged dataflow graph(s) may be optimized to obtain one or more optimized merged dataflow graph(s) and, in turn, the optimized merged dataflow graph(s) may be executed. The optimizations may be designed to reduce the amount of computational resources used to execute the merged dataflow graph(s) and, therefore, executing the optimized merged dataflow graph(s) utilizes fewer computational resources than would executing the merged dataflow graph(s) prior to performing optimization. Although it is possible to optimize the dataflow graphs being merged, prior to the merging them, and then merge individually optimized dataflow graphs to obtain the merged dataflow graph(s) (and this technique may be used in some embodiments), it may be advantageous to apply the optimization techniques to the merged dataflow graph(s) because certain optimizations that were not applicable to individual dataflow graphs (prior to merging) may become applicable to the merged dataflow graph(s). Optimizing the merged dataflow graph(s) (or even the dataflow graphs prior to merging, in some embodiments), increases the speed with which the merged dataflow graph(s) (and therefore the converted SSD application overall) executes and reduces the computational resources utilized by the merged dataflow graph(s) during execution.

As described herein, the techniques described herein may be used to convert application programs written in any of numerous types of source SQL dialects. Examples of source SQL dialects include, but are not limited to, Hive Query Language (HQL), SNOWFLAKE SQL. Spark SQL. PySpark, DB2 SQL, BIGQUERY SQL, and TERADATA SQL. Also, as described herein, converting an application program written in a source SQL dialect to one or more dataflow graphs may involve first translating the script(s) in the application program from a source SQL dialect to a target SQL dialect. Examples of the target SQL dialect include, but are not limited to, ANSI-92 SQL, ANSI SQL from any other year (e.g., ANSI-2003 SQL), or PostgreSQL.

In some embodiments, translating the plurality of SSD statements into the respective plurality of target SQL dialect (TSD) statements comprises: for each particular SSD statement in the plurality of SSD statements, performing one or more of: translating a command in the particular SSD statement to a corresponding command in the target SQL dialect; translating a type or a function in the particular SSD statement to corresponding type or function in the target SQL dialect; resolving one or more variables in the SSD statement; and obtaining a data manipulation language (DML) definition for a table referenced in the particular SSD statement. Aspects of translating SSD to TSD statements are described herein, including with reference to FIG. 5B.

As described herein, a TSD statement may be converted to a dataflow graph. For example, in some embodiments, converting a TSD statement to a dataflow graph comprises: generating a query plan from the TSD statement, the query plan identifying one or more data processing operations to be performed if the TSD statement were executed, and generating the dataflow graph from the query plan, wherein the dataflow graph includes a node for each of at least some of the one or more data processing operations identified in the query plan. Aspects of converting TSD statements to dataflow graphs are described herein, including with reference to FIG. 5A.

With respect to merging dataflow graphs to obtain merged dataflow graphs, graphs that read in and write out a common dataset may be connected such that, instead of writing out a dataset (e.g., at the end of computations performed by executing dataflow graph A) and then reading the very same dataset (e.g., at the start of computations to be performed by executing dataflow graph B), the dataset (e.g., the records within the dataset) may be provided from one graph to the other (e.g., from a node in the graph A to a node in graph B). In this way, unnecessary and time-consuming reading and writing of records to memory (e.g., a data store, disk, etc.) can be avoided.

Accordingly, in some embodiments, the plurality of dataflow graphs includes: a first dataflow graph configured to write out a particular dataset, a second dataflow graph configured to read in the particular dataset, and wherein merging the dataflow graphs comprises: configuring, as part of a merged dataflow graph, the second dataflow graph to receive the particular dataset from the first dataflow graph.

In some embodiments, the first dataflow graph has a first output node representing a data processing operation for writing data to the particular dataset, the second dataflow graph has a second input node representing a data processing operation for reading data from the particular dataset, and the configuring comprises adding an edge from the first output node to the second input node, the edge representing flow of data from the first dataflow graph to the second dataflow graph.

In some embodiments, merging the plurality of dataflow graphs comprises: identifying one or more input datasets that at least one dataflow graph of the plurality of dataflow graphs is configured to read in; identifying one or more output datasets that one or more dataflow graphs of the plurality of dataflow graphs is configured to write out; comparing the one or more input datasets and the one or more output datasets; determining, based on results of the comparing, that a first dataflow graph in a pair of dataflow graphs, among the plurality of dataflow graphs, is configured to write out a particular output dataset of the one or more output datasets and a second dataflow graph in the pair of dataflow graphs is configured to read in the particular output dataset; and introducing, as part of one of the one or more merged dataflow graphs, an edge representing a flow of data from the first dataflow graph to the second dataflow graph.

In some embodiments, a dataflow graph may include components, termed “nodes” or “vertices,” representing data processing operations to be performed on input data and links between the components representing flows of data. Nodes of a dataflow graph may include one or more input nodes representing respective input datasets, one or more output nodes representing respective output datasets, and one or more nodes representing data processing operations to be performed on data. An input node may represent any suitable type of data store. Similarly an output node may represent any suitable type of data store.

In some embodiments, different data processing operations represented by different nodes in a dataflow graph may be executed using different respective computer system processes. For example, a dataflow graph may include a first node representing a first data processing operation (e.g., a “sort” operation) and a second node representing a second data processing operation different from the first data processing operation (e.g., a “join” operation) and, in some embodiments, a first computer system process may be used to execute the first data processing operation and a second computer system process, which is different from the first computer system process, may be used to execute the second data processing operation. In some embodiments, the first and second computer system processes may execute on the same computing device and, for example, may be managed by the same operating system. In other embodiments, the first and second computer system processes may execute on different computing devices.

In some embodiments, a computer system process used to execute a data processing operation represented by a node in a dataflow graph may be an instance of a computer program configured to execute processor-executable instructions for encoding the data processing operation. A computer system process may be a single-threaded or a multi-threaded process. A computer system process may be associated with one or more computer system resources including, by way of example and not limitation, processor-executable instructions representing encoding the data processing operation, memory (e.g., a region of physical and/or virtual memory which holds executable code, process-specific input and/or output data, a call stack, a computation heap, and/or other data), a process identifier (e.g., used by an operating system to identify the computer system process), security attributes (e.g., permissions indicating one or more owners of the process and/or operations that the computer system process is allowed to perform), and/or information specifying the state of the computer system process.

It should be appreciated that the techniques introduced above and discussed in greater detail below may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

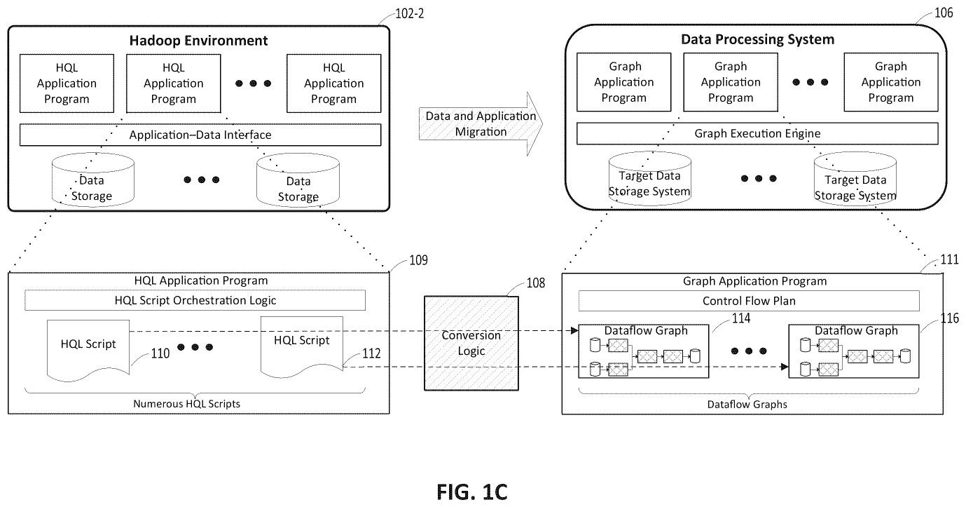

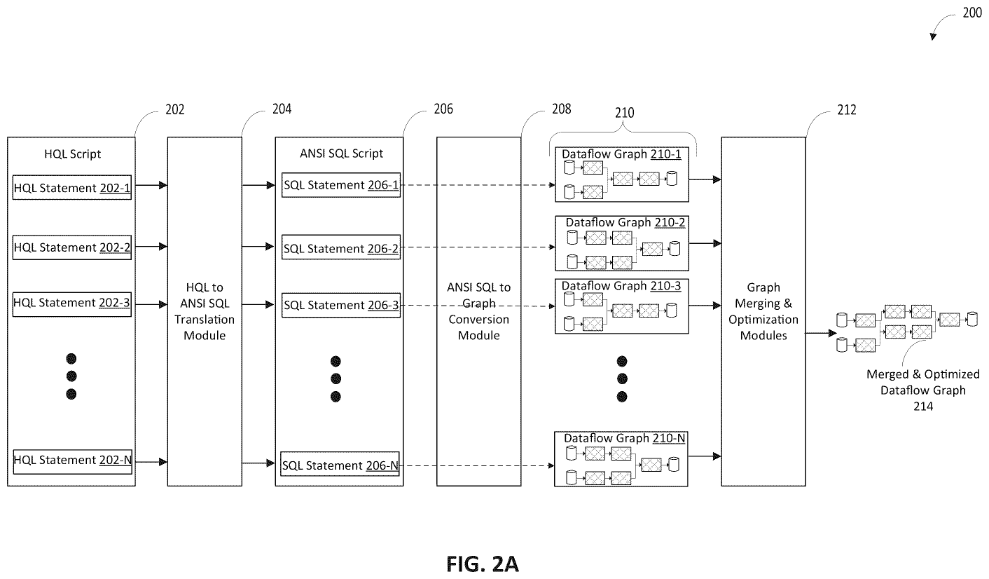

FIG. 2A is a block diagram 200 illustrating conversion of an application program written in Hive Query Language (HQL) to a computer program embodied by one or more dataflow graphs, in accordance with some embodiments of the technology described herein. The illustration in FIG. 2A is an adaptation of (the more general) FIG. 2B to the specific use case of converting an HQL application program including one or multiple HQL scripts, including at least HQL script 202, to respective dataflow graphs.

As shown in FIG. 2A, HQL script 202 is converted to ANSI SQL (e.g., ANSI-92 SQL) script 206 by HQL-to-ANSI SQL translation module 204, which may be a version of SSD-to-TSD translation module 254 described with respect to FIG. 2B that contains code to translate HQL statements to ANSI SQL statements. In particular, HQL-to-ANSI SQL translation module 204 translates each of the HQL statements in the HQL script 202 to a respective ANSI SQL statement in ANSI SQL Script 206. For example, HQL statements 202-1, 202-2, 202-3, . . . , 202-N are translated by HQL-to-ANSI SQL translation module 204 to corresponding ANSI SQL statements 206-1, 206-2, 206-3, . . . , 206-N.

In turn, the ANSI SQL script 206 is converted to dataflow graphs 210 by SQL-to-graph conversion module 208, which may be a version of the SQL-to-graph conversion module 258 described with reference to FIG. 2B that contains code to translate ANSI SQL statements to corresponding dataflow graphs. In particular, SQL-to-graph conversion module 208 converts each of the ANSI SQL statements in the ANSI SQL script 206 to respective dataflow graphs in dataflow graphs 210. For example, ANSI statements 206-1, 202-6, 206-3, . . . , 206-N are translated by the SQL-to-graph conversion module 208 to corresponding dataflow graphs 210-1, 210-2, 210-3, . . . , and 210-N.

Next, the dataflow graphs 210 are merged, by graph merging and optimization modules 212, to obtain the merged and optimized dataflow graph 214. In turn, the dataflow graph 214 may be executed, for example using a graph execution engine. In some embodiments, all of the dataflow graphs part of dataflow graphs 210 (which can include dataflow graphs derived from HQL statements from one or multiple HQL script) may be merged to obtain a single merged dataflow graph, which upon being (optionally) optimized, results in the merged and optimized dataflow graph 214, as shown in FIG. 2A. However, in some embodiments, only some of the dataflow graphs 210 may be merged such that multiple dataflow graphs result subsequent to this step-fewer than the number of dataflow graphs constituting dataflow graphs 210 but greater than one because not all dataflow graphs would have been merged into a single dataflow graph. In some such embodiments, the multiple resulting dataflow graphs may be (optionally) optimized and executed in order to perform the functionality of HQL script 202 and or HQL application that includes the HQL script 202, as the case may be. In yet other embodiments, the merging step may be omitted entirely and the dataflow graphs 210 may be executed (optionally, after one or more of the dataflow graphs 210 is individually optimized prior to execution). Graph merging and optimization modules 212 may be implemented in the same way as graph merging and optimization modules 262, as described referring to FIG. 2B.

FIG. 2B is a block diagram 250 illustrating conversion of an application program written in a source structured query language (SQL) dialect to a computer program embodied by one or multiple dataflow graphs, in accordance with some embodiments of the technology described herein. As shown in FIG. 2B, the application program includes source SQL dialect (SSD) script 202 that is converted, through a sequence of steps in the illustrated computational pipeline, to merged and optimized dataflow graph 264. Although only a single SSD script is shown in FIG. 2B, this is for clarity of presentation, as an application program may include one or multiple SSD scripts (e.g., 2, 3, 5, 10, 15, 20, 25, 30, 35, 40, 45, 50, 75, 100, more than one scripts, between 2 and 50 scripts, between 10 and 100 scripts, or any other range within these ranges). In addition, when an SSD application program includes multiple SSD scripts, SSD statements in all these script may be translated to TSD statements, subsequently converted to dataflow graphs, which may then be merged to obtain one or multiple merged dataflow graphs (e.g., a single merged dataflow graph representing the entire SSD application program, multiple merged dataflow graphs representing respective SSD scripts or other groupings of SSD statements).

As shown in FIG. 2B, SSD script 252 includes multiple SSD statements 252-1, 252-2, 252-3, . . . 252-N. An SSD script may include any suitable number of statements (e.g., 1, 2, 3, 4, 5, 6, 7, 8, 9, 10, 15, 20, 25, 30, 35, 40, 45, 50, 75, 100, 250, 500, 1000, more than 1000, between 1 and 50, between 10 and 100, between 50 and 500, between 100 and 1000, or any other suitable range within these ranges), as aspects of the technology described herein are not limited in this respect.

As shown in FIG. 2B, the source SQL dialect script 252 is translated to target SQL dialect (TSD) script 256 by SSD-to-TSD translation module 254. In particular, SSD-to-TSD translation module 254 translates each of the SSD statements in the SSD script 252 to a respective TSD statement in TSD 256. For example, SSD statements 252-1, 252-2, 252-3, . . . , 252-N are translated by SSD-to-TSD translation module 254 to corresponding TSD statements 256-1, 252-6, 256-3, . . . 256-N. Aspects of how the translation is performed by SSD-to-TSD translation module 254 are described herein including with reference to FIGS. 5A-5C.

The SSD script may be written in any source SQL dialect and the TSD script may be written in any target SQL dialect so long as SSD-to-TSD translation module 254 contains code to translate from the source SQL dialect to the target SQL dialect. Examples of source and target SQL dialects are provided herein.

Next, as shown in FIG. 2B, the TSD script 256 is converted to a plurality of dataflow graphs 260 by the SQL-to-graph conversion module 258. In particular, the SQL-to-graph conversion module 258 converts each of the TSD statements in the TSD script 256 to a respective dataflow graph among dataflow graphs 260. For example, TSD statements 256-1, 252-6, 256-3, . . . , 256-N are translated by the SQL-to-graph conversion module 258 to corresponding dataflow graphs 260-1, 260-2, 260-3, . . . , 260-N. Aspects of how the conversion is performed by SQL-to-graph conversion module 258 are described herein including with reference to FIGS. 5A-5C.

Next, as shown in FIG. 2B, the dataflow graphs 260 are merged, by graph merging and optimization modules 262 to obtain one more merged dataflow graph, which may then be optimized to obtain, in this example, a single merged and optimized dataflow graph 264. In turn, the single merged and optimized dataflow graph 264 may be executed, for example using a graph execution engine to perform the functionality of SSD script 252.

In some embodiments, all of the dataflow graphs part of dataflow graphs 260 may be merged to obtain a single merged dataflow graph, which upon being (optionally) optimized, results in the merged and optimized dataflow graph 264, as shown in FIG. 2B. Although dataflow graphs 260 are shown (for clarity) as containing dataflow graphs derived from SSD statements in a single SSD script, it should be appreciated that dataflow graphs 260 may include dataflow graphs derived from SSD statements in one or multiple (or all) SSD scripts in the SSD application program. In some embodiments, the merging step results in multiple merged dataflow graphs (e.g., one per SSD script, one per collection of SSD statements across different SSD scripts). Each such merged dataflow graph may be optimized to obtain a respective optimized merged dataflow graph and then executed. In yet other embodiments, the merging step may be omitted entirely and the dataflow graphs 260 may be executed (optionally, after one or more of the dataflow graphs 260 is individually optimized prior to execution). Aspects of how the graph merging and optimization modules 262 operate are described herein including with reference to FIGS. 5A-5C.

FIG. 3A is a schematic diagram illustrating conversion of an application program 300 written in HQL into a graph application program 305, with multiple HQL scripts 304 and HQL script orchestration logic 302 of the application program 300 being converted to multiple dataflow graphs 308 corresponding to the multiple HQL scripts 304 and a control flow plan 306 corresponding to the HQL script orchestration logic 302, in accordance with some embodiments of the technology described herein. The illustration in FIG. 3A is an adaptation of (the more general) FIG. 3B to the specific use case of converting an HQL application program 300 including one or multiple HQL scripts 304 to respective dataflow graphs 308.

As shown in FIG. 3A, the conversion of application program 300 to graph application program 305 involves: (1) converting HQL scripts 304 to dataflow graphs 308; and (2) converting HQL script orchestration logic 302 to control flow plan 306. The conversion of the HQL scripts to respective dataflow graphs may be performed using the techniques described herein including with reference to FIG. 2A. For example, the computational pipeline shown in FIG. 2A can be used to convert HQL scripts 304-1, 304-2, 304-3, etc. to respective dataflow graphs 308-1, 308-2, 308-3, etc. Thus, each particular one of the dataflow graphs 308 may be a merged and optimized dataflow graph resulting from taking SSD statements from a particular SSD script, translating them to TSD statements, converting the TSD statements to respective dataflow graphs and merging the dataflow graphs to obtain the particular one of the dataflow graphs 308.

FIG. 3B is a schematic diagram illustrating conversion of an application program 350 written in a source SQL dialect into a graph application program 355, in accordance with some embodiments of the technology described herein.

As shown in FIG. 3B, application program 350 includes multiple source SQL dialect scripts 354 (including source SQL dialect scripts 354-1, 354-2, 354-3, . . . ) and source SQL dialect script orchestration logic 352. The source SQL dialect script orchestration logic 352 controls the sequence in which multiple SSD scripts 354 execute. The orchestration logic 352 may specify a partial (or total) ordering on the SSD scripts 354 so that any dependencies among them are handled appropriately (e.g., by ensuring that an SSD script B that relies on results generated by SSD script A executes only after SSD script A has generated the results that SSD script B relies on). For example, the orchestration logic 352 may require that certain SSD scripts execute serially and/or allow that certain SSD scripts may execute in parallel. Accordingly, upon being executed in a computing environment suitable for execution of SSD scripts and logic, the source SQL dialect script orchestration logic 352 may cause the multiple SSD scripts 354 to execute in a designed and specified sequence.

As shown in FIG. 3B, the conversion of application program 350 to graph application program 355 involves: (1) converting SSD scripts 354 to dataflow graphs 358; and (2) converting SSD script orchestration logic 352 to control flow plan 356. The conversion of the SSD scripts to respective dataflow graphs may be performed using the techniques described herein including with reference to FIG. 2B. For example, the computational pipeline shown in FIG. 2B can be used to convert SSD scripts 354-1, 354-2, 354-3, etc. to respective dataflow graphs 358-1, 358-2, 358-3, etc. Thus, each particular one of the dataflow graphs 358 may be a merged and optimized dataflow graph resulting from taking SSD statements from a particular SSD script, translating them to TSD statements, converting the TSD statements to respective dataflow graphs and merging the dataflow graphs to obtain the particular one of the dataflow graphs 358. Although in the examples of FIG. 3A and FIG. 3B, each SSD script is converted to a respective merged dataflow graph, FIG. 3C shows that in some embodiments the number of merged dataflow graphs generated by conversion need not be in a one-to-one relationship with the number of scripts. For example, a single merged dataflow graph may be generated from multiple SSD scripts. For example, as shown in FIG. 3C, two merged dataflow graphs (e.g., 378-1 and 378-2) may be generated from three SSD scripts (e.g., 354-1, 354-2, 354-3). As another example, the SSD scripts 354 may include between 20 and 100 SSD scripts each of which may include between 10 and 50 SSD statements and the techniques described herein may be used to convert such an application program (having between 200 and 5000 SSD statements) into a single merged dataflow graph (which may be further optimized) or a small number of merged dataflow graphs, resulting in a dramatic overall increase in performance (due to increased throughput, parallelism and elimination of unnecessary operations, among other reasons).

The SSD orchestration logic 352 may be converted to control flow plan 356 in any suitable way. For example, in some embodiments, the SSD orchestration logic 352 may be converted automatically (e.g., by a software program configured to perform such conversion) to the control flow plan 356. In other embodiments, the SSD orchestration logic 352 may be converted manually to the control flow plan 356. In some embodiments, the conversion may be done in part manually and in part automatically (e.g., by automatically generating an initial control flow plan based on the orchestration logic with a user subsequently, manually, configuring and/or adjusting the automatically generated control flow plan to obtain a finalized control flow plan).

In some embodiments, the control flow plan 356 may be implemented using a control flow graph. Thus, the orchestration logic 352 may be converted to a control flow graph. A control flow graph is executable. The control flow graph may be configured to orchestrate execution of the dataflow graphs 358. As such, the control flow graph may be executed to cause the dataflow graphs part of dataflow graphs 358 to execute in a specified sequence. For example, the control flow graph may define a partial ordering of the dataflow graphs 358 indicating that execution of a certain dataflow graph is to complete before execution of another dataflow graph begins. Additional aspects of control flow graphs are described in U.S. Pat. No. 10,489,191, filed on Oct. 6, 2016, and titled “Controlling Tasks Performed By A Computing System Using Controlled Process Spawning”, which is incorporated by reference herein in its entirety.

FIG. 4A illustrates a data processing system for converting an application program 404 written in a source SQL dialect and configured to execute in a source SQL dialect environment 402 into a computer program 424 embodied by one or more dataflow graphs and executing the resulting computer program, in accordance with some embodiments of the technology described herein.

The techniques developed by the inventors may be used to convert SSD application program 404 executing in SSD environment 402. The SSD application program 404 may include SSD script orchestration logic 406 and one or more SSD scripts 408-1, . . . , 408-N. Each of the SSD scripts may be configured to read data (e.g., data records) from and/or write data (e.g., data records) to database system(s) 412 via query language interface 410. For example, the database system(s) may be a TERADATA database and the SSD scripts may be written in TERADATA SQL and, upon being executed, may be configured to read and/or write data to the TERADATA database via query language interface 410.

Data processing system 420 may use software part of conversion modules 422 to convert the SSD application program 404 to graph application program 424. The conversion modules 422 may include one or more (e.g., all) of the modules shown in conversion modules 560 described herein including with reference to FIG. 5C. As shown with dash-dotted arrows, the conversion modules may be used to convert SSD script orchestration logic 406 to control flow plan 426 and to convert SSD scripts 408-1, . . . , 408-N to respective dataflow graphs 428-1, . . . , 428-N. It should be appreciated that although in the examples of FIGS. 4A-4C, each SSD script is converted into a respective merged dataflow graph, in other cases the SSD scripts may be converted into one (i.e., a single) merged dataflow graph or a number of merged dataflow graphs that is not equal to (e.g. lower than) the number of SSD scripts, as aspects of the technology described herein are not limited in this respect.

Data processing system 420 further includes a graph execution engine 430 that may be used to execute the graph application 424. In particular, the graph execution engine 430 may be configured to execute any of the dataflow graphs part of graph application program 424 as well as control flow plan 426 (e.g., when the control flow plan is implemented as a control flow graph). The graph execution engine 430 may comprise a co-operating system or any other suitable execution environment for executing dataflow graphs. Aspects of environments for developing and executing dataflow graphs are described in U.S. Pat. No. 5,966,072, titled “Executing Computations Expressed as Graphs,” and in U.S. Pat. No. 7,716,630, titled “Managing Parameters for Graph-Based Computations,” each of which is incorporated by reference herein in its entirety.

During execution of the dataflow graphs 428-1, . . . , 428-N, one or more of these dataflow graphs may be configured to read data from and/or write data to one or more of the data stores 432-1, 432-2, . . . , 432-K. In some embodiments, one or more of these data stores may store data migrated over from database system(s) 412. In this way, all of the processing previously performed in the SSD environment 402 and the data on which such processing is performed can be migrated to a different computing environment external to SSD environment 402. Namely, the processing and data can be migrated to the environment defined by the data processing system 420 and the data stores 432-1, . . . , 432-K, all of which are external to SSD environment 402. Additionally or alternatively, the data processing system can be configured to communicate with database system(s) 412 via communication link 417 (which may be achieved using one or more communication networks, for example). Such communication can be used to facilitate migration of data from database system(s) 412 to one or more data store(s) 432-1, . . . , 432-K and/or allow continued access to such data (e.g., for reading and/or writing) within database system(s) 412. Each of the data stores 432-1, . . . , 432-K may be of any suitable type, examples of which are provided herein.

FIG. 4B illustrates a data processing system 421 that provides a variation on the data processing system 420 shown in FIG. 4A in that the software for converting SSD application program 404 to graph application program 424 is not part of the data processing system 421. In particular, as shown in FIG. 4B, data processing system 421 does not include the conversion modules 442. The conversion modules 442 include the software to convert the SSD application program 404 to graph application program 424. The conversion modules 442 may include one or more (e.g., all) of the modules shown in conversion modules 560 described herein including with reference to FIG. 5C. Thus, conversion modules may be part of a data processing system (as shown in FIG. 4A) or be outside of the data processing system (as shown in FIG. 4B). In yet other embodiments, not illustrated, it is conceivable that one or more of the conversion modules may be part of a data processing system and one or more other of the conversion modules may be outside of the data processing system, as aspects of the technology described herein are not limited in this respect—conversion logic may reside in any suitable system or systems.

FIG. 4C is an adaptation of FIG. 4A to the setting where the source SQL dialect is SQL. In particular, FIG. 4C illustrates a data processing system 470 for converting an HQL application program 454 and configured to execute in a Hadoop environment 452 (e.g., a Hadoop cluster) into a graph application program 474, in accordance with some embodiments of the technology described herein.

As shown in FIG. 4C, HQL application program 454 includes HQL scripts 458-1, . . . , 458-N. One or more of these HQL scripts is configured to read and/or write data, via query language interface 460 (e.g., an HQL interface) from a distributed data warehouse system (e.g., Apache HIVE) that stores data in a distributed file system 464 (e.g., Apache Hadoop Distributed File System (HDFS)) having distributed file system (DES) nodes 465-1, 465-2, . . . , 465-N, where N can be any suitable number of DFS nodes in the distributed file system 464.

The data processing system 470 includes conversion modules 472 that convert HQL scripts 458-1, . . . , 458-N to respective dataflow graphs 478-1, . . . , 478-N and HQL script orchestration logic 456 to control flow plan 476. (Though it should be appreciated that the conversion module 472 may also convert the N HQL scripts into M HQL scripts where M is not equal to N and, for example, where M=1, so that only a single merged dataflow graph results from the overall conversion process). The dataflow graphs part of graph application program 374 may execute using graph execution engine 480 (which may be implemented as graph execution engine 430) and, during execution, may read and/or write values from one or more of the data stores 482-1, 482-2, . . . , 482-K. Each of the data stores 482-1, . . . , 482-K may be of any suitable type, examples of which are provided herein.

FIG. 5C is a block diagram of an example data processing system 552 for converting application programs written in a source SQL dialect and configured to execute in a source SQL dialect environment into respective computer programs, each embodied by one or multiple dataflow graphs, and executing the resulting computer programs, in accordance with some embodiments of the technology described herein.

As shown in FIG. 5C, data processing system includes conversion modules 560, graph application programs 570, and graph execution engine 580. The data processing system 552 is communicatively coupled to one or more data stores 590-1, 590-2, . . . 590-N, which are shown as being external to the data processing system 552, though in other embodiments one or more (e.g., all) of the data stores 590-1, . . . , 590-N may be part of data processing system 552, as aspects of the technology described herein are not limited in this respect.

Conversion modules 560 include SSD application analysis module 561, source-to-target SQL dialect translation module 562, SQL-to-graph conversion module 563, graph merging module 564, and graph optimization module 565.

In some embodiments, the SSD application analysis module 561 contains code that, when executed by the data processing system 550, causes the data processing system to analyze an SSD application to identify information that will be used for translating the SSD application into a target SQL dialect and converting the resulting TSD statements to dataflow graphs, as described herein with reference to FIG. 5A. For example, the data processing system may determine whether command names from the SSD application are to be translated into command names of the target SQL dialect. If so, the data processing system may generate a translation script to perform the translation. As another example, the data processing system may identify one or more types, functions, and/or other expressions that are to be translated. As another example, the data processing system may identify variables in SSD statements that need to be resolved prior to translation into the target SQL dialect. As another example, the data processing system may identify tables for which a data manipulation language (DML) definition is needed. If any such table is identified, the data processing system may generate a translation script that generates a DML definition for the table.

In some embodiments, the source-to-target SQL dialect translation module 562 contains code that, when executed by the data processing system 552, causes the data processing system 552 to translate one or more source SQL dialect statements into one or more corresponding target SQL dialect statements as described herein including with reference to FIGS. 5A and 5B.

In some embodiments, the SQL-to-graph conversion module 563 contains code that, when executed by the data processing system 552, causes the data processing system 552 to convert each of one or more TSD statements in a TSD script into respective dataflow graphs, as described herein including with reference to FIG. 5A.

In some embodiments, the graph merging module 564 contains code that, when executed by the data processing system 552, causes the data processing system 552 to merge multiple dataflow graphs (e.g., ones obtained using the SQL-to-graph conversion module) into one or more merged dataflow graphs, as described herein including with reference to FIG. 5A.

In some embodiments, the graph optimization module 565 contains code that, when executed by the data processing system 552, causes the data processing system 552 to optimize dataflow graphs (e.g., merged dataflow graphs generated by the graph merging module 564 and/or dataflow graphs generated by the SQL-to-graph conversion module), as described herein including with reference to FIG. 5A and in the Section titled “Dataflow Graph Optimizations.”

The conversion modules 560 may convert SQL application programs written in a source SQL dialect to respective graph application programs, as described herein. Accordingly, graph application programs 570 may include one or more such converted programs, shown in the FIG. 5C as graph application programs 572-1, . . . , 572-N. Each of the graph application programs may include one or more dataflow graphs and, in cases where a graph application program has multiple dataflow graphs, the graph application program may further include a control flow graph to orchestrate execution of the multiple dataflow graphs part of the graph application program.

The graph execution engine 580 may comprise a co-operating system or any other suitable execution environment for executing dataflow graphs. Aspects of environments for developing and executing dataflow graphs are described in U.S. Pat. No. 5,966,072, titled “Executing Computations Expressed as Graphs,” and in U.S. Pat. No. 7,716,630, titled “Managing Parameters for Graph-Based Computations,” each of which is incorporated by reference herein in its entirety.

A data store may store any suitable type of data in any suitable way. A data store may store data as a flat text file, a spreadsheet, using a database system (e.g., a relational database system), or in any other suitable way. In some instances, a data store may store transactional data. For example, a data store may store credit card transactions, phone records data, or bank transactions data. It should be appreciated that data processing system 552 may be configured to access any suitable number of data stores of any suitable type, as aspects of the technology described herein are not limited in this respect. A data store from which data processing system 552 may be configured to read data may be referred to as a data source. A data store to which data processing system 552 may be configured to write data may be referred to as a data sink.

Each of the data stores 590-1, 590-2, . . . , 590-N may be of any suitable type. In some embodiments, the data stores 590-1, 590-2, . . . , 590-N may be of a same type (e.g., all may be relational databases) or different types (e.g., one may be relational database while another may be a data store that stores data in flat files. A data store may be a SQL server data store, an ORACLE data store, a TERADATA data store, a flat file data store, a multi-file data store, a HADOOP data store, a DB2 data store, a Microsoft SQL SERVER data store, an INFORMIX data store, a SAP data store, a MongoDB data store, a metadata datastore, and/or or any other suitable type of data store, as aspects of the technology described herein are not limited in this respect.

FIG. 5A is a flowchart of an illustrative process 500 for converting an application program written in a source SQL dialect into a respective computer program embodied by one or more dataflow graphs and executing the respective computer program, in accordance with some embodiments of the technology described herein. Process 500 may be performed by any suitable computing device(s). In some embodiments, process 500 may be performed by a data processing system, for example, any one of data processing systems 420, 421, 470, or 552 described herein.

Process 500 begins at act 502, where a source SQL dialect (SSD) application program is obtained. The SSD application program may include one or multiple SSD scripts. Each of the SSD scripts may include one or more SSD statements. Each of the SSD scripts may be in any suitable format and may be organized in any suitable number of files, as aspects of the technology described herein are not limited in this respect. For example, the SSD application may be accessed from one or more directories of files and each of at least some of the files may contain an SSD script. Examples of source SQL dialects are provided herein.

Next, at act 504, the SSD application is analyzed to identify information that may be used to translate SSD statements in the SSD application to corresponding statements in the target SQL dialect and/or to convert the resulting TSD statements into corresponding dataflow graphs. The analysis may be performed automatically using software, for example, software part of the conversion modules 560. For example, in some embodiments, the software for performing act 504 is part of SSD application analysis module 561.

In some embodiments, the analysis performed at act 504 involves parsing the SSD scripts part of the SSD application and identifying, within each SSD script, SSD statements that are to be translated from the source to the target SQL dialect (and converted to respective dataflow graphs subsequent to the translation). For each identified SSD statement, the analysis may involve identifying one or more SSD statement components (e.g., commands, types, function names, expressions, variables) and determining whether such SSD statement component(s) need to be translated from the source to the target SQL dialect and/or whether any other action (e.g., changing the command name, resolving a variable, changing a type definition, etc.) needs to be taken in furtherance of the translation to the target SQL dialect and/or subsequent conversion to a dataflow graph.

In some embodiments, act 504 may involve generating, based on results of the analysis performed, one or more translation scripts (i.e., generating software code) that when executed will translate SSD statements in the SSD application to corresponding TSD statements that are suitable for subsequent conversion into dataflow graphs, in accordance with some embodiments of the technology described herein. For example, act 525 described with reference to FIG. 5B, may be performed by executing one or more translation scripts generated at act 504. In other embodiments, the results of the analysis performed at act 504 may be used by other software code to perform the translation of one or more SSD statements, as aspects of the technology described herein are not limited in this respect.

In some embodiments, the analysis performed at act 504 may involve identifying portions of the SSD scripts that may not be necessary to translate. Examples of such portions are provided herein including with reference to act 520 of process 550 described with reference to FIG. 5B. The act 504 may further involve marking such portions for subsequent removal (e.g., with special symbols, commenting, etc.) and/or removing such portions outright. Alternatively, the act 504 may involve generating translation scripts that, when executed (e.g., as part of process 550) mark such portions for subsequent removal and/or remove them.

In some embodiments, the analysis performed at act 504 may involve identifying commands (e.g., command names) in the SSD statements and determining whether the command names are to be translated from the source to the target SQL dialect. For example, the command “INSERT OVERWRITE” may be identified (an HQL command in this example) and it may be determined that, because this command does not exist in the target SQL dialect (e.g., PostgreSQL), this command is to be translated into a command that is supported by PostgreSQL (e.g., to “INSERT INTO”). This information may be used to perform the translation during act 508 (e.g., as implemented, for example, by process 550 in FIG. 5B at act 525) and/or may be used to generate a translation script that may perform this translation when invoked during act 508.

In some embodiments, the analysis performed at act 504 may involve identifying one or more types, functions, and/or other expressions of the SSD statements in the SSD application program that are to be translated from the source to the target SQL dialect. Examples of such types, functions and/or other expressions are provided herein including with reference to act 526 of process 550 described with reference to FIG. 5B. The act 504 may further involve generating translation scripts that, when executed (e.g., as part of process 550), translate such identified types, functions, and/or expressions from the source to the target SQL dialect.

In some embodiments, the analysis performed at act 504 may further involve identifying variables in the SSD statements part of the SSD application program. The analysis may involve identifying environment variables and/or bind variables. Because, as described with reference to act 528 of process 550, environment variables may need to be resolved as part of the translation process from the source to the target SQL dialect, act 504 may involve identifying values of the environment variables (to which values the variables will be resolved as part of the translation). The act 504 may further involve generating translation scripts that, when executed (e.g., as part of process 550), resolve the identified environment variables.

In some embodiments, the analysis performed at act 504 may involve identifying any tables for which a data manipulation language (DML) definition is needed. The act 504 may further involve generating translation scripts that automatically generate such definitions where needed and/or such information can be used as part of process 550 to facilitate either manual, partially automated, or fully automated generation of such DML definitions (e.g., as described with reference to act 530 of process 500).

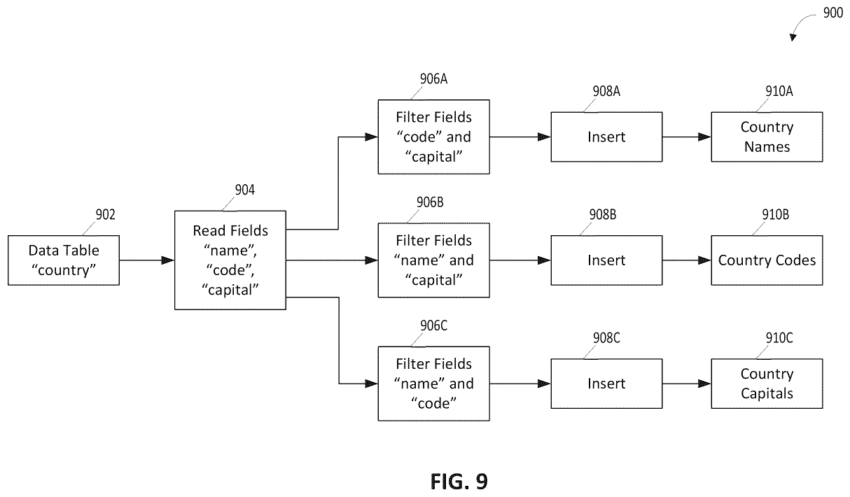

In some embodiments, the analysis performed at act 504 may involve identifying tables which are read multiple times. The analysis may involve identifying SSD statements in the SSD application program that each read the same table (e.g., to read a different field from the table). For example, identifying the SSD statements in the SSD application program that each read the same table may involve identifying multiple select statements that each selects data from the same table. Example SSD statements that may be identified are described herein with reference to FIG. 9.

In some embodiments, the analysis performed at act 504 may involve determining whether to jointly convert multiple statements from the SSD application program into a single dataflow graph or to convert the statements individually into multiple respective dataflow graphs which are subsequently merged. There are situations where each of these two approaches has its benefits.

In some cases, for example, jointly converting the multiple statements together into a single dataflow graph may result in an improved dataflow graph. For example, converting the multiple statements together into a single dataflow graph may reduce the number of times a data source is read-reading the same data source multiple times is a significant computational burden. As another example, converting the multiple statements together into a single dataflow graph may result in a dataflow graph that is more efficiently executed than dataflow graphs generated by converting each of the statements individually.

In other cases, however, converting the multiple statements individually into separate dataflow graphs and subsequently merging them may result in a more efficient dataflow graph. For example, converting the multiple statements individually may allow specification of additional information per statement that can facilitate the generation of a more efficient to execute dataflow graph. For example, a statement be converted may create a table for which a partition key may not be established until the table is created. Processing that statement individually may allow the opportunity to insert a partition key. In contrast, converting the statement in a group with other statements may not allow specification of a partition key for the table. As another example, converting statements individually may allow the determination of information about data created by statements. To illustrate, the number of rows that are created in a data table created by a statement may be determined and used to convert the statement into a more efficiently executed dataflow graph. For example, the number of rows may be used to implement a join operation more efficiently.

As described above, in some embodiments, act 504 may involve generating translation scripts to perform various translation tasks described herein. Any suitable number of translation scripts may be generated for this purpose. For example, a single translation script may perform multiple different translation tasks or only a single translation task. As another example, one or multiple translation scripts may be generated for translating each individual SSD script.

Next, at act 506, one of the SSD scripts in the SSD application is obtained for processing at acts 508 and 510 to translate (at act 508) the SSD statements in the SSD script into respective TSD statements and to convert the TSD statements (at act 510) into respective dataflow graphs.

First, at act 508, the SSD statements in the SSD script obtained at act 506 are translated to corresponding target SQL dialect (TSD) statements. The translation may be performed automatically using software, for example, software part of the conversion modules 560. For example, in some embodiments, the software for performing act 508 is part of source-to-target SQL dialect translation module 562.

In some embodiments, translating a particular SSD statement into a corresponding TSD statement may include performing one or more of: (a) translating a command in the SSD statement to a corresponding command in the target SQL dialect; (b) translating a type, a function, or other type of expression in the particular SSD statement to corresponding type, function, or expression in the target SQL dialect; (c) resolving one or more variables (e.g., one or more environment variables) in the particular SSD statement; and/or (d) obtaining a data manipulation language (DML) definition for a table referenced in the particular SSD statement. Aspects of translating SSD statements into respective TSD statements are described herein including with reference to FIG. 5B.

In some embodiments, the translation may involve translating SSD statements (e.g., identified at act 504) that were identified as reading the same data source (e.g., the same table). The SSD statements may be translated into one or more TSD statements that read the particular data source once. In some embodiments, each of the SSD statements that reads the data source may access different data from the table (e.g., a different field of the table). Translating the SSD statements may involve translating them into TSD statements that each apply a filter to data read from the data source to obtain data targeted by a respective one of the SSD statements. Accordingly, the translation may translate different SSD statements that read the same data source multiple times into a set of TSD statements that: (1) read the data source once; and (2) apply filters to the data obtained from reading the data source to obtain different subsets of data that were accessed by the different SSD statements. An example such translation is described herein with reference to FIG. 9.

Next, at act 510, each of the TSD statements obtained during the translation performed at act 508 is converted to a respective dataflow graph. The conversion may be performed automatically using software, for example, software part of the conversion modules 560. For example, in some embodiments, the software for performing act 510 is part of SQL-to-graph conversion module 563.

In some embodiments, converting a TSD statement into a dataflow graph may comprise: (1) generating a query plan from the TSD statement; and (2) generating the dataflow graph from the generated query plan. The generated query plan may identify one or more data processing operations to be performed if the TSD statement (e.g., an ANSI SQL or PostgreSQL query) were executed. The generated query plan may further specify an order in which the identified data processing operations are to be executed. As such, the generated query plan may represent a sequence of data processing operations to perform in order to execute the TSD statement. The SQL-to-graph conversion module 563 may be configured to generate a query plan from the TSD statement in any suitable way. For example, in some embodiments, the SQL-to-graph conversion module 563 may implement any of the techniques for generating query plans described in U.S. Pat. No. 9,116,955, titled “Managing Data Queries,” which is incorporated by reference herein in its entirety.

In turn, the query plan may be used to generate the dataflow graph, which may be done in any suitable way including by implementing any of the techniques for generating dataflow graphs from query plans that are described in U.S. Pat. No. 9,116,955, titled “Managing Data Queries,” which is incorporated by reference herein in its entirety.

In some embodiments, the dataflow graph may be generated from a query plan at least in part by generating the dataflow graph to include a node for each of at least a subset (e.g., some or all) of the data processing operations identified in the query plan. Subsequently, the order of data processing operations specified in the query plan may be used to generate links (which may be referred to as edges) connecting nodes in the dataflow graph. For example, when the generated query plan indicates that a first data processing operation is performed before a second data processing operation, the generated dataflow graph may have a first node (representing the first data processing operation) and a second node (representing the second data processing operation) and one or more links specifying a path from the first node to the second node.

In some embodiments, generating the dataflow graph from the query plan comprises adding one or more nodes to the graph representing input and/or output data sources. For example, generating the dataflow graph may comprise adding an input node for each of the data sources from which data records are to be read during execution of the TSD statement. Each of the input nodes may be configured with parameter values associated with the respective data source. These values may indicate how to access the data records in the data source. As another example, generating the dataflow graph may comprise adding an output node for each of the data sinks to which data records are to be written during execution of the TSD statement. Each of the output nodes may be configured with parameter values associated with the respective data sinks. These values may indicate how to write the data records to the data source.

The dataflow graph generated from the query plan is different from the query plan. Dataflow graphs, as that term is used herein, are executable. By contrast, query plans are not executable. For example, the dataflow graph generated from the query plan can be executed by a graph execution engine (e.g., graph execution engine 580), whereas a query plan cannot be executed by the graph execution engine—it is an intermediate representation that is used to generate the dataflow graph, which dataflow graph is executed by the graph execution engine in order to execute the TSD statement. A query plan is not executable and, even in the context of a relational database management system, it needs to be further processed to generate an execution strategy. By contrast, a dataflow graph is executable, for example by the graph execution engine, in order to perform the TSD statement.

In some embodiments, converting the multiple TSD statements into a dataflow graph may comprise: (1) identifying multiple TSD statements that read the same data source (e.g., the same table); and (2) re-writing the TSD statements such that the data source is read only once. The re-written TSD statements may further apply filtering operations to the data read from the data source to obtain the different datasets that were accessed by the different TSD statements. The downstream operations involving data accessed by one of the original TSD statements may then be applied to a corresponding filtered set of data generated by the re-written TSD statements.

Next, at decision block 512, the process 500 determines whether there are any other SSD scripts part of the SSD application program (obtained at act 502) that contain SSD statements which have not yet been converted to respective dataflow graphs. If there is such an SSD script that has not been converted to a respective dataflow graph, process 500 proceeds, via the “Yes” branch, to act 506 where that unconverted SSD script is accessed and acts 508 and 510 are repeated for that script to convert the SSD statements in it to respective dataflow graphs. On the other hand, if there are no other SSD scripts to convert, then process 500 proceeds to act 514.

Next, at act 514, the dataflow graphs obtained by converting individual SSD statements in the SSD application programs may be merged to obtained one or multiple merged dataflow graphs. The merging may be performed automatically using software, for example, software part of the conversion module 560. For example, in some embodiments, the software for performing act 512 is part of graph merging module 564.

In some embodiments, the merging performed at act 514 graphs may result in a single merged dataflow graph, which would perform the functionality of the entire SSD application program.

In some embodiments, merging the dataflow graphs at act 514 may result in multiple merged dataflow graphs. As one example, a merged dataflow graph may be obtained per SSD script part of the SSD application program. That is, for each SSD script, the SSD statements in that SSD script may be translated to corresponding TSD statements, the TSD statements are each converted to respective dataflow graphs and these dataflow graphs are merged to a single merged dataflow graph representing the functionality of the SSD script. In this way, a merged dataflow graph may be obtained for each SSD script. As another example, multiple merged dataflow graphs may result from the merging processing, but the resulting merged dataflow graphs are not in a one-to-one relationship with the SSD scripts. For instance, dataflow graphs obtained from SSD statements in different SSD scripts may be merged (e.g., because a dataflow graph G1 obtained from an SSD statement in one SSD script outputs a dataset D that another dataflow graph G2 obtained from SSD statement in another SSD script takes in as input). In this way, dataflow graphs obtained from the same or different SSD scripts may be merged.

Overall, the merging (or “stitching” as it may be sometimes referred to) performed at act 514 is flexible in that it allows dataflow graphs obtained from SSD statements across the entire SSD application to potentially be merged to obtain one or multiple merged dataflow graphs embodying the SSD application.

In some embodiments, the merging at act 514 may be performed iteratively, whereby a merged graph is constructed by merging in one dataflow graph at a time. For example, after all the TSD statements have been converted to respective dataflow graphs (defining a “set” of dataflow graphs to be merged), a merged dataflow graph may be constructed by introducing a first dataflow graph into the merged dataflow graph and, iteratively, stitching into the merged dataflow graph being constructed one dataflow graph at a time from the set of dataflow graphs to be merged. However, it should be noted, that in other embodiments, dataflow graphs may be processed for merging two or more at a time, as aspects of the technology described herein are not limited to merging graphs iteratively only one dataflow graph at a time.

In some embodiments, constructing the merged dataflow graph involves adding one or more dataflow graphs (e.g., one a time, if processing iteratively) as subgraphs into the merged dataflow graph being constructed. Upon adding a dataflow graph as a subgraph (or multiple dataflow graphs as subgraphs) into the merged dataflow graph being constructed, the input and output datasets accessed by the dataflow subgraph(s) being added are identified (e.g., using a unique dataset ID, parameters defining how the dataset is accessed and/or stored, etc.). The identified input and output datasets are “elevated” out of the subgraphs being added into the merged dataflow graph (e.g., they may be represented by new input and output nodes in the merged dataflow graph). In this way, input and output nodes corresponding to these input and output datasets may then be removed from the individual subgraphs being merged and instead inserted into the merged dataflow graph being created. As a result, the merged dataflow graph contains input node(s) corresponding to the identified input dataset(s) and output node(s) corresponding to the identified output dataset(s). Upon being “elevated” in this way, the input and output datasets accessed by the various subgraphs are each specified, once, at the level of the merged dataflow graph.

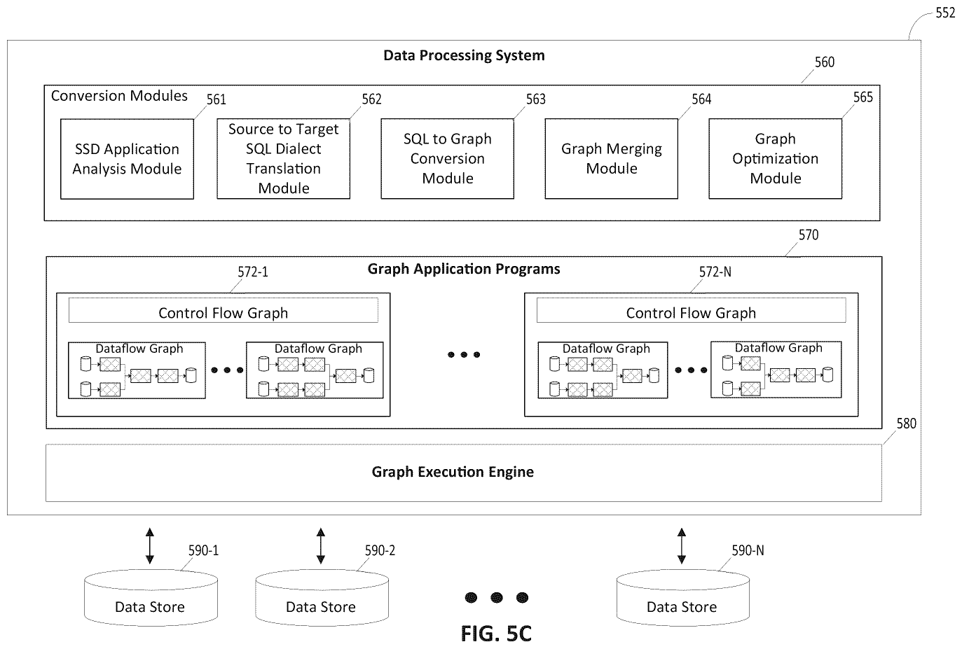

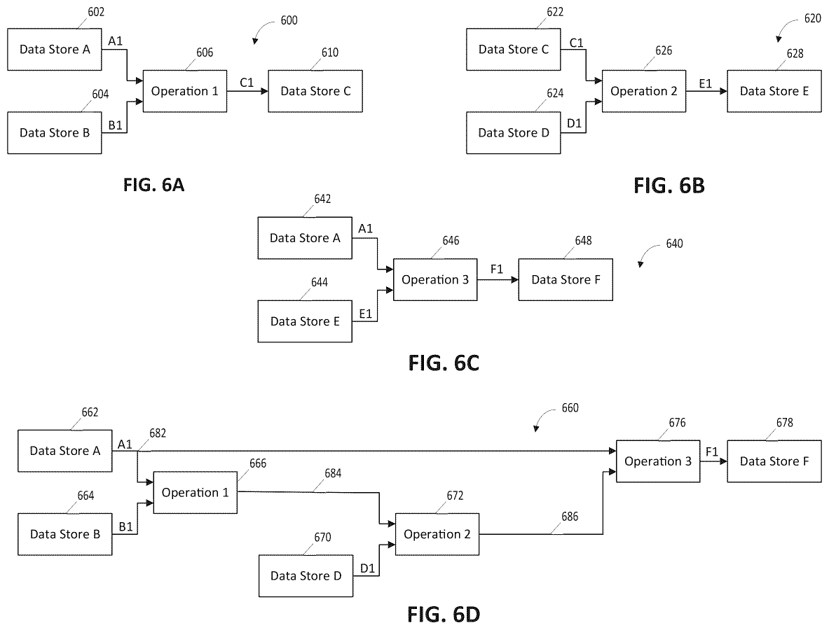

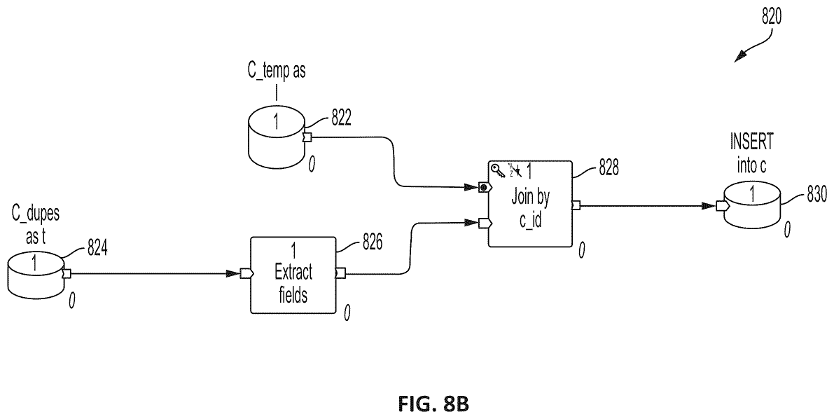

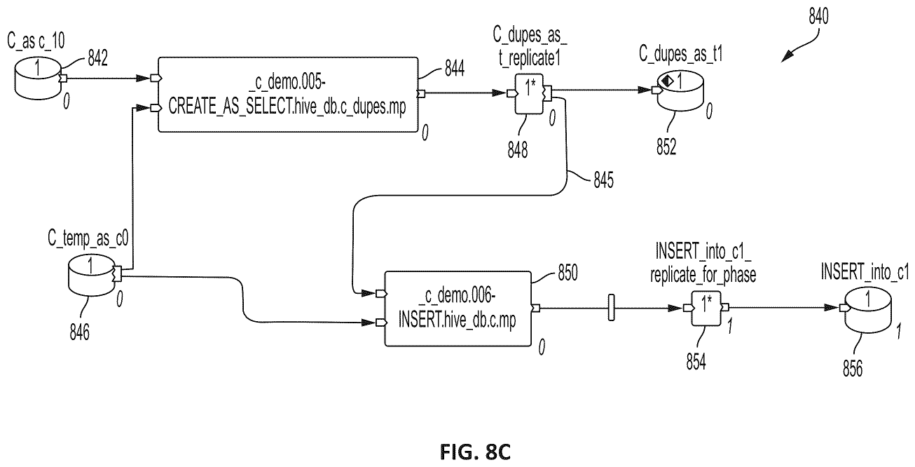

In turn, the subgraphs being merged and then connected to the “elevated” nodes representing the input dataset(s) and/or output dataset(s). When a subgraph being merged reads from an input dataset that has been previously elevated into the merged dataflow graph, the subgraph may be connected to the node representing the input dataset in the merged dataflow graph. When a subgraph being merged writes to an output dataset that has been previously elevated into the merged dataflow graph, the subgraph may be connected to the node representing the output dataset in the merged graph. Importantly, where a dataset D output by a dataflow subgraph G1 is read later by another dataflow subgraph G2 (in the merged dataflow graph), the outputting from G1 of dataset D to a datastore (e.g., the writing by dataflow graph G1 of dataset D into a database) may be replaced by a flow of the dataset D from dataflow graph G1 to the input nodes of graph G2. In this way, unnecessary writing and reading of the dataset D to a datastore (e.g., a database) is avoided. Though in some such embodiments, the flow from G1 to G2 may be added together with a conditional output such that the dataset D can nonetheless be written out (e.g., to disk) for debugging or other purposes. An example of such a conditional output is described below with respect to the example merged dataflow graph shown in FIG. 8C, whereas the example of the merged dataflow graph shown in FIG. 6D does not have such a conditional output.

After the input and output datasets are elevated and the subgraphs are stitched to them and/or one another to form the merged dataflow graph, one or more parameters of the subgraphs may be elevated to the level of the merged dataflow graph and deduplicated so that they are managed as one unit with respect to the merged dataflow graph, especially if some of the same parameters appear in different dataflow subgraphs. In addition, one or more environment variables (e.g., variables pointing to schemas or datasets) that may have been resolved (such that their values are known) in the TSD statements prior to conversion into dataflow graphs may be re-parameterized in graph dataset references.

In addition, in the merged dataflow graph, one or more portions of the dataflow graph may be specified to execute in phases such that the merged dataflow graph is a multi-phase graph. Generally, a multi-phase graph has its components separated into two or more “phases”, which execute sequentially in a predefined order because of a dependency. For example, a multi-phase graph may include three phases: a first phase, a second phase, and a third phase, each including one or more components. In operation, the components of the second phase do not begin processing data until the components of the first phase complete their processing. Similarly, the components of the third phase do not begin processing data until the components of the second phase complete their processing. An example of such phasing is shown in the example of FIG. 8C, which has two phases indicated by “0” and “1”, where the components in phase “1” do not begin processing data until components in phase “0” complete their processing. Such phasing information may be derived, in part, from the orchestration logic associated with the SSD applications and/or information about how to best execute the resulting graph (e.g., DROPs are placed into phase ‘0’ and DELETEs are placed into one or more subsequent phases), in some embodiments. Aspects of phased dataflow graphs are described in U.S. Pat. No. 9,886,241, titled “Managing interfaces for sub-graphs”, filed on Dec. 5, 2014, which is incorporated by reference herein in its entirety.

In some embodiments, merging the dataflow graphs may involve identifying multiple dataflow graphs that each read the same data source (e.g., the same table) and generating merged dataflow graph(s) that read the data source once. For example, multiple components of different dataflow graphs that read data from the data source may be merged into a single component that reads data from the data source. The output of the component that reads the data from the data source may be provided as input (e.g., along a link or edge) to a filtering operation to obtain data that was originally output by one of the dataflow graphs prior to merging. Accordingly, the merged dataflow graph(s) may reduce the number of times that the data source is read (e.g., such that the data source is only read once by the merged dataflow graph(s)). FIG. 9 shows an example of generating a dataflow graph that combines multiple operations of reading a data source into a single operation (e.g., as part of performing process 500).

Next, we turn to examples of merging individual dataflow graphs into merged dataflow graphs. The first example is shown in FIGS. 6A-6D. Each of FIGS. 6A-6C shows a respective illustrative dataflow graph previously obtained (e.g., at act 510 of process 500) from a respective target SQL dialect statement, while FIG. 6D illustrates a merged dataflow graph obtained by merging the dataflow graphs shown in FIGS. 6A-6C.

In more detail, FIG. 6A shows dataflow graph 600 having input node 602 representing a data processing operation for reading dataset A1 from data store A, input node 604 representing a data processing operation for reading dataset B1 from data store B, node 606 representing data processing operation 1 (e.g., a join) to be performed on the datasets read from the data sources A and B, and an output node 610 representing a data processing operation for writing an output dataset C1 to data store C.

FIG. 6B shows dataflow graph 620 having input node 622 representing a data processing operation for reading the dataset C1 from data store C, input node 624 representing a data processing operation for reading a dataset D1 from data store D, node 626 representing data processing operation 2 to be performed on the datasets read from the data stores C and D, and an output node 628 representing a data processing operation for writing an output dataset E1 to data store E.

FIG. 6C shows dataflow graph 640 having input node 642 representing a data processing operation for reading dataset A1 from data store A, input node 644 representing a data processing operation for reading dataset E1 from data store E, node 646 representing data processing operation 3 to be performed on the datasets read from the data stores A and E, and an output node 648 representing a data processing operation for writing an output dataset F1 to data store F.

FIG. 6D shows the dataflow graph 660 obtained by merging the dataflow graphs 600, 620, and 640, in accordance with some embodiments. Dataflow graph 660 includes input nodes 662, 664, and 670 configured to read datasets A1, B1, and D1, from data stores A, B, and D, respectively. The input nodes 662, 664, and 670 represent input nodes elevated out of the individual dataflow graphs being merged. Dataflow graph 660 further includes node 666 representing data processing operation 1 to be performed on datasets read from data stores A and B, node 672 representing data processing operation 2 to be performed on the output of data processing operation 1 (represented by node 666) and the dataset D1 read from data store D, and node 676 representing data processing operation 3 to be performed on the dataset A1 read from data store A and the output of data processing operation 2. Dataflow graph 660 further includes node 678 configured to write the output dataset F1 to data store F.

As is readily seen from this example, dataset A1 from data store A is used by both dataflow graphs 600 (FIG. 6A) and 640 (FIG. 6C). The dataset C1 written to data store C by dataflow graph 600 is read from the data store C by dataflow graph 620. The dataset E1 written to data store E by dataflow graph 620 is read from data store E is read by dataflow graph 640. Thus, if the dataflow graphs were to be executed individually rather than be merged as in FIG. 6D, the impact would be that the same dataset A1 is read twice from data store A, the same dataset C1 is written and read from data store C, and the same dataset E1 is written and read from data store E. As such, in this example, merging the dataflow graphs shown in FIGS. 6A-6C provides an opportunity to avoid reading data from and/or writing data to data sources more times than required.

Indeed, in the merged dataflow graph 660 shown in FIG. 6D, dataset A1 is read from data source A only once, then sent (as illustrated by split 682) to different nodes 666 and 676 (e.g., by being provided to different computer processes that are executing the data processing operations represented by nodes 666 and 676). Substantial processing time (and computing resources) savings are obtained by reading the dataset A1 only once from the data store A, rather than twice as the case would be if the dataflow graphs 600, 620, and 640 were executed separately.

As another example, the write to and read from data store C is eliminated in the merged dataflow graph 660 (though in other embodiments, the write to datastore C may be maintained, for example for debugging purposes). Merging the graphs 600 and 620 involves connecting the nodes 610 and 622 by introducing an edge between them and, further, if the same dataset and being written to and read from data store C (as is the case in this example with dataset C1), the write and read can be eliminated and the data produced as a result of operation 1 (node 666) can flow directly via link 684 to be used as input for operation 2 (node 672). Similarly, the write and read to data store E is eliminated in the merged dataflow graph 660. Merging the graphs 620 and 640 involves connecting the nodes 628 and 644 by introducing an edge (representing a flow) between them and, further, if the same dataset is being written to and read from data store E (as is the case in this example with dataset E1), the write and read can be eliminated and the data produced as a result of operation 2 (node 672) can flow directly via link 686 to be used as input for operation 3 (node 676).

Moreover, as can be seen in this example, if the dataflow graphs 600, 620, and 640 were not merged and, instead, were executed on their own, their execution would need to be sequenced due to the dependencies among them. The dataflow graph 620 would only execute after execution of dataflow graph 600 is completed (because of the dependency through dataset C1), and dataflow graph 640 would only execute after execution of dataflow graph 620 is completed (because of the dependency through dataset E1). By contrast, the merged dataflow graph would provide pipeline parallelism. This provides for greater throughput because, records can be processed in parallel by multiple operations and in a streaming architecture. For example, once a record is read from dataset A1 it can be sent for processing to operation 1 and operation 3. As another example, as soon as two records are processed by operation 1 (one record from dataset A1 and dataset B1) the result of that processing can be sent to operation 2 and data processing operation 2 can be performed using a record read from dataset D1. In turn, the result of operation 2 can be processed (together with the already read record from dataset A1) by data processing operation 3. As a result, the throughput of processing by the merged dataflow graph is substantially increased relative to what is possible by executing the dataflow graphs on their own. In the streaming architecture enabled by the merged dataflow graph, results may be written to data store F even before all the data is read from the data stores A. B, and D, which is not possible with sequential execution of the individual dataflow graphs 600, 620, and 640, in this example.

Another example of merging two dataflow graphs into a merged dataflow graph is shown in FIGS. 8A, 8B, and 8C. FIGS. 8A and SB show dataflow graphs 800 and 820, respectively. And FIG. 8C shows dataflow graph 840 obtained by merging the dataflow graphs 800 and 820 shown in FIGS. 8A and 8B.

As shown in FIG. 8A, dataflow graph 800 contains input nodes 802 and 804 configured to read datasets “C_temp” and “C”, respectively. The dataset “C_temp” is processed at node 808 to extract certain fields of interest, the result of which is joined at node 812 (an inner join), on the key “bus_key_txt” (the ‘0’ in the label on in the figure, just shows temp variable) with results of processing the dataset “C” at node 806 to extract certain fields of interest and group (e.g., rollup) the resulting records by the “bus_key_txt” field at node 810. The wider records obtained at the output of node 812 are scanned to identify duplicates in tables C and C_temp. These duplicate records are written out to the dataset “C_dupes” at node 816.

As shown in FIG. 8B, the dataflow graph 820 contains input nodes 822 and 824 configured to read datasets C_temp and C_dupes, respectively. After fields of interest are extracted, at node 826, from the dataset C_dupes they the records from C_dupes are joined at node 828 with records from the dataset C_temp and written out to C (the same dataset as was read in at node 804). It should be noted that the phase of all components in the separate dataflow graphs 800 and 820 are phase 0.

FIG. 8C shows a dataflow graph 840 resulting from merging of the dataflow graphs 800 and 820, in accordance with some embodiments of the technology described herein. In particular, dataflow graph 840 contains input nodes 842 and 846 configured to read datasets C and C_temp. These datasets are sent to the subgraph 844 representing the operations in dataflow graph 800 (i.e., the operations represented by nodes 806, 808, 810, 812, and 814 in dataflow graph 800). The dataset C_temp is also sent to the subgraph 850 representing the operations in dataflow graph 820 (i.e., operations represented by nodes 826 and 828 in dataflow graph 820). Notably, because dataflow graph 820 read as input the dataset C_dupes that was written out by dataflow graph 800, in the merged dataflow graph 840, there is a flow 845 (represented by an edge in the dataflow graph) from the subgraph 844 to the subgraph 850. In addition, there is a conditional output node 848 (which is optional in this example) that can be used to write out dataset C_dupes if of separate interest, for example for debugging. The output of subgraph 850 is replicated at 854 and written into dataset C. It should be noted that in this example, the merged graph is a multi-phase graph with components 854 and 856 being in a second phase (denoted by “1”) whereas all the other components are in a first phase (denoted by “0”). That is because, in this example, the data is being rewritten back into the same dataset C. As such all the records from that dataset need to be first read and processed prior to being overwritten.

In this example, as is the case in the example of FIGS. 6A-6D, there are numerous benefits to executing the merged dataflow graph 840 rather than the individual dataflow graphs 800 and 820. First, the merged dataflow graph 840 reads the dataset C_temp only once rather than twice if the graphs 800 and 820 were separately executed. Second, assuming the conditional output is not on for debugging purposes, the dataset C_dupes need not be unnecessarily written out and read in; rather the dataset would simply flow from dataflow subgraph 844 (e.g., from the node 814 it contains) to dataflow subgraph 850 (e.g., to the node 826 it contains) along edge 845. Finally, the overall processing speed of processing the records is improved because of the pipeline parallelism made possible by the structure of the merged dataflow graph 840. In particular, the data read from datasets C and C_temp can be processed in parallel by subgraphs 844 and 850 (they are in the same phase of execution—phase “0”), whereas if the dataflow graphs were executed separately, their execution would need to be sequenced.

Returning back to process 500, after the merging is performed at act 514 to obtain one or more merged dataflow graphs, the merged dataflow graph(s) may be optimized at act 516 to obtain one or more respective optimized merged dataflow graph(s). The optimization may be performed automatically using software, for example, software part of the conversion module 560. For example, in some embodiments, the software for performing act 514 is part of graph optimization module 565.

Each merged dataflow graph generated at act 514 (recall one or multiple such graphs may be generated at act 514) may present various opportunities for optimization that would lead to more computationally efficient execution post optimization. For example, a merged dataflow graph generated at 514: (1) may include nodes that represent redundant data processing operations; (2) may require performing data processing operations whose results are subsequently unused; (3) may require unnecessarily performing serial processing in cases where parallel processing is possible; (4) may apply a data processing operation to more data than needed in order to obtain a desired result: (5) may break out computations over multiple nodes, which significantly increases the computational cost of performing the computations in situations where the data processing for each dataflow graph node is performed by a dedicated thread in a computer program, a dedicated computer program (e.g., a process in an operating system), and/or a dedicated computing device; (6) may require performing a stronger type of data processing operation that requires more computation (e.g., a sort operation, a rollup operation, etc.) when a weaker type of data processing operation that requires less computation (e.g., a sort-within-groups operation, a rollup-within-groups operation, etc.) will suffice; and/or (7) may require the duplication of processing efforts.

One or more optimizations of any of numerous types of optimizations may be applied, at act 516, to one or more of the merged dataflow graph generated at act 514. For example, in some embodiments, the one or more optimizations may involve: removing at least one node of the merged dataflow graph (e.g., when the node represents a redundant data processing operation or a data processing operation whose results are not subsequently used), parallelizing processing of at least one operation represented by least one node in the merged dataflow graph, deleting data records processed in at least one node of the merged dataflow graph such that these data are not used in subsequent operations represented by nodes downstream of the at least one node in the merged dataflow graph, combining multiple nodes in the merged dataflow graph into a single node, replacing at least one node of the merged dataflow graph with one or more other nodes (e.g., to apply a strength-reduction optimization), and/or changing an order of nodes in the merged dataflow graph to facilitate application of optimization rules.

The optimization may be performed using any suitable optimizations applicable to dataflow graphs including, but not limited to, any of the (e.g., some or all) of the optimization techniques described below in the section titled “Dataflow Graph Optimizations” and/or in U.S. Pat. Pub. No. 2019-0370407, filed on May 30, 2018, published on Dec. 5, 2019, and titled “Systems and Methods For Dataflow Graph Optimization,” which is incorporated by reference herein in its entirety.

At act 518, the optimized merged dataflow graph(s) obtained during execution of process 500 (these optimized merged graph(s) representing functionality of the SSD scripts part of the SSD application program), may be executed. In some embodiments, the optimized merged graph(s) may be executed using a graph execution engine, for example, graph execution engine 580 described with reference to FIG. 5C. During execution, the optimized merged graph(s) may read and/or write data to one or more data stores, for example, one or more of the data stores 590-1, 590-2, . . . 590-N described with reference to FIG. 5C.

It should be appreciated that process 500 described with reference to FIG. 5A is illustrative and that there are variations. For example, in some embodiments, the process 500 may include the further act of converting the SSD script orchestration logic to a control flow plan (e.g., a control flow graph). The SSD script orchestration logic may be converted to a control flow plan in any suitable way, examples of which are provided herein. The resulting control flow plan may be used to orchestrate execution of the dataflow graph(s) at act 518. For example, when the control flow plan is implemented as a control flow graph, the control flow graph may be executed by the graph execution engine 580 in order to orchestrate execution (by the graph execution engine) of the phases of the generated dataflow graph(s).

As another example, there are variations on whether and when to optimize the various dataflow graphs generated during process 500. For example, in some embodiments, the merged dataflow graph(s) generated at act 514 may not be optimized, with act 516 being omitted. In this case, the merged dataflow graph(s) are executed (without being optimized) at act 518. As another example, in some embodiments, the dataflow graphs generated at act 510 may be optimized (e.g., using the logic of the graph optimizer module 565) prior to being merged. The merged graph may be optimized again at act 514, to take advantage of any further opportunities for optimization that become available as a result of the graphs being merged, or that act may be omitted such that the optimization is performed only prior to merging and not after. As yet another example, in some embodiments, the act 514 of merging may be omitted. In such embodiments, at least one (e.g., some or all) of the dataflow graphs generated at act 510 may be optimized at 516 and executed at 518. This embodiment also provides substantial improvements with respect to execution of SSD application program relative to how that program would have executed in the original SSD environment because of the pipeline parallelism and optimization provided in the context of dataflow graphs.

Yet another variation relates to serial vs parallel processing. As shown in FIG. 5A, the SSD scripts are converted serially, one after the other. However, in other embodiments, two or more or all of the SSD scripts, part of the SSD application program, may be converted in parallel, as aspects of the technology described herein are not limited in this respect.

As described herein with reference to FIG. 5A, in some embodiments, converting an SSD application program into one or more dataflow graphs may involve generating a dataflow graph that reduces a number of times that data is read from a data source (e.g., such that the data source is only read from once in the dataflow graph). As described herein, this may be performed in various ways. For example, SSD script(s) of an application program may be translated into TSD script(s) a lower number of times (e.g., once). Dataflow graph(s) may be generated from the TSD script(s). As another example, SSD script(s) may be re-written as part of the conversion such that the number of times data is read from a data source is reduced. Dataflow graph(s) may be generated from the re-written SSD script(s). As another example, one or more dataflow graphs generated from an SSD application program may be modified (e.g., merged) to reduce the number of times that the data source is read (e.g., by modifying the dataflow graph(s) to only read the data source once). FIG. 9 shows an illustrative dataflow graph 900 generated from an SSD application program by converting an SSD script of an application program into a TSD script that reduces the number of times a data source is read and then generating a dataflow graph from the TSD statement, according to some embodiments of the technology described herein. The SSD application program may include the following SSD script.

insert into tmp.p1
select name from tmp.country
where name like ‘A%’;
insert into tmp.p2
select code from tmp.country
where name like ‘B%’
insert into temp.p3
select capital from tmp.country
where name like ‘C%’;

In the above SSD script, the data table “country” is read three separate times. The data table is: (1) read a first time to select values of the “name” field that begin with the letter “A”; (2) a second time to select values of the “code” field that begin with the letter “B”; and (3) a third time to select values of the “capital” field that begin with the letter “C”.

The SSD application program including the above SSD script may be converted into the dataflow graph 900 in various ways. In some embodiments, the SSD script may be converted into a TSD script that reads from the data source once, and then converted into the dataflow graph 900. For example, the SSD script above may be re-written as follows.

SELECT
counry.name AS name,
country.code AS code,
country.capital AS capital
FROM tmp.country AS country
WHERE {country.name LIKE ‘A%’} or {country.name LIKE ‘B%’} or
{country.name LIKE ‘C%’}

In the above example, the SSD script is transformed into a TSD script in which the “where” clause conditions with the three separate “select” statements of the SSD script are combined into a single “where” clause associated with a “select” statement in the TSD script. The conditions from the “where” clauses of the SSD script are unionized as the condition of the “where’ clause in the TSD script. In some embodiments, the TSD script generated from the SSD script may include additional statements that filter the results of the “select” statement for downstream operations. For example, the TSD script may include a statement to filter out the “code” and “capital” fields from the data obtained from reading “country” table for downstream operations specific to the “name” field.

The TSD script may then be converted into the dataflow graph 900 shown in FIG. 9. As shown in FIG. 9, the dataflow graph 900 includes a single read operation 904 to read the fields “name”, “code”, and “capital” from the data table “country” 902. The read operation 904 may read the field values that meet the condition specified by the “where” clause in the TSD script that the SSD script was translated into. The dataflow graph 900 includes operations downstream of the read operation 904 that operate separately on each of the fields. Accordingly, the dataflow graph 900 includes a filter operation 906A to filter out the “code” and “capital” fields to obtain only the data from the “name” field. An insert operation 908A is performed on the filtered data obtained from the filter operation 906A to write the data from the “name” field to the “country names” dataset 910A. The dataflow graph 900 includes a filter operation 906B to filter out the “name” and “capital” fields to obtain only the data from the “code” field that was read from the data table “country” 902. An insert operation 908B is performed on the filtered data obtained from the filter operation 906B to write the data from the “code” field to the “country codes” dataset 910B. The dataflow graph 900 includes a filter operation 906C to filter out the “name” and “code” fields to obtain only the data from the “capital” field that was read from the data table “country” 902. An insert operation 908C is performed on the filtered data obtained from the filter operation 906C to write the data from the “capital” field to the “country capitals” dataset 910C. The dataflow graph 900 may be more efficient to execute than a dataflow graph that reads the data table “country” 902 multiple times to separately obtain the “name”, “code”, and “capital” fields.

As illustrated by the example of FIG. 9, in some embodiments, all statements from an SSD script that read from the same table may be converted into a single read operation of a dataflow graph. The statements from the SSD script may be referred to as a “compatible unit”. The compatible unit may be converted together into a read operation.

FIG. 5B is a flowchart of an illustrative process 550 for translating source SQL dialect (SSD) statements into corresponding target SQL dialect (TSD) statements, in accordance with some embodiments of the technology described herein. Process 550 may be used to implement act 508 of process 500, as described with reference to FIG. 5A.

Initially, after a particular SSD script is obtained at act 506, the SSD script is preprocessed at act 520. As part of the pre-processing, certain portions of the SSD script may be identified as unnecessary to translate (or may have previously been identified as unnecessary to translate, for example, at act 504 of process 500) and are removed. For example, in some embodiments, preprocessing the SSD script may involve identifying portions of the SSD script that are not necessary to translate, commenting them out, and subsequently removing out any such commented portions. As another example, in some embodiments, preprocessing the SSD script may involve identifying portions of the SSD script that may not be necessary to translate and removing them directly, without first commenting them out, as aspects of the technology described herein are not limited in this respect.

There are numerous types of code in an SSD script that are may not be necessary to translate and that may be removed. Non-limiting examples include: comments, session commands, certain metadata, array definitions, certain elements HQL syntax that may not be necessary to translate (e.g., the “EXTERNAL”, “IF EXISTS”, “IF NOT EXISTS”, “PURGE”, and “PARTITIONED BY” elements of HQL syntax). In one illustrative example, the following session commands may be commented out (e.g., using a symbol such as—[toRemove] or any other symbol) and subsequently removed:

-- [toRemove] set session.variable1;
-- [toRemove] set session.variable2;

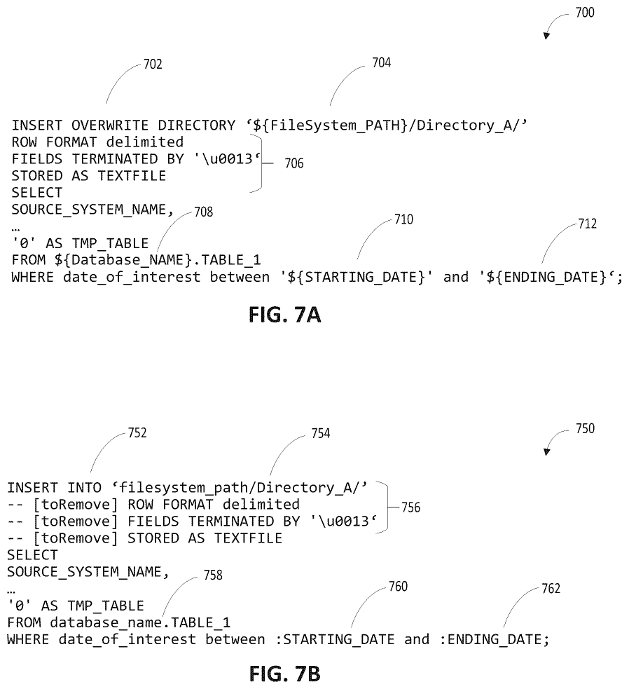

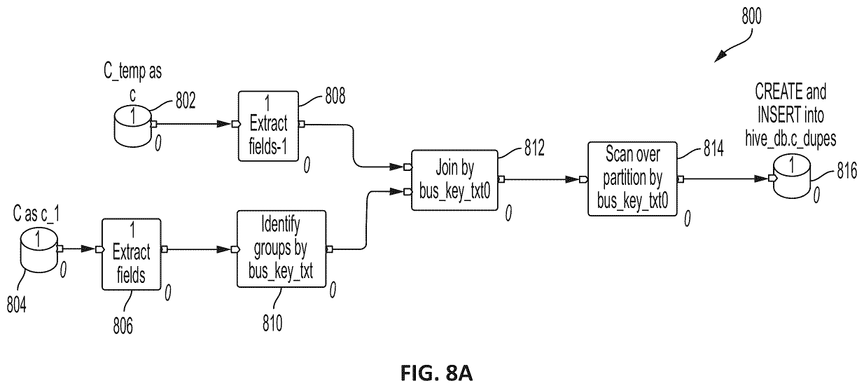

In another illustrative example, the source metadata 706 shown in FIG. 7A may be removed. As another illustrative example, the following source metadata may be commented out and subsequently removed:

--[toRemove] Delimiters used by rows
--[toRemove] Fields terminated by Unicode character A
--[toRemove] Keys terminated by Unicode character B

In another illustrative example, the “IF EXISTS” and “PARTITIONED BY” commands may be removed:

-- DROP TABLE ${Database_db1].table_A -- [toRemove] IF EXISTS
-- [toRemove] PURGE
-- [toRemove] PARTITIONED BY (target_date)
-- [toRemove] STORED AS ABC

After the preprocessing performed at act 520, process 550 proceeds to act 522 where an SSD statement in the SSD script is selected in order to be translated at act 525 (which in this illustrative example includes acts 524, 526, 528, and 530). Selecting an SSD statement for translation may involve parsing the SSD script to identify the locations (e.g., line numbers) of the SSD statements in the SSD script or relying on such identification if it has already been performed, for example, at act 504 of process 500.

After the selected SSD statement is translated, at act 525, to a corresponding TSD statement, process 550 proceeds to decision block 532 where it is determined whether another SSD statement is to be translated. When it is determined that another SSD statement is to be translated, the process 500 returns to act 522 where the other SSD statement is selected for translation and is translated at act 525. On the other hand, when it is determined that there are no further SSD statements to be translated (e.g., indicating that all the SSD statements in the SSD script have been translated) process 550 moves to act 510 (previously described with respect to FIG. 5A), where each of the TSD statements (obtained as a result of translation) are converted to respective dataflow graphs.

Turning to the act of translation 525, after an SSD statement is selected at act 522, one or more commands of the SSD statement may be translated from the source SQL dialect to the target SQL dialect at act 524, one or more types, functions, and/or other expressions of the SSD statement may be translated from the source SQL dialect to the target SQL dialect at act 526, one or more variables in the SSD statement may be resolved at act 528, and DML may be obtained for one or more tables referenced in the SSD statement at act 530.

It should be appreciated that not all of these acts, part of 525, are always executed for each SSD statement. For example, a command may not need to be translated because it is the same command (i.e., the same string) in the source and target SQL dialects. Thus, for a particular SSD statement, any one, two, three or all four of acts 524, 526, 528, and 530 may be performed depending on the nature of the SSD statement being translated. Moreover, one or more other acts may be performed in service of translation, in addition to or instead of the acts shown as part of act 525 in this illustrative example. It should be appreciated while some aspects of the translation process (e.g., the specific target dialect strings for commands, types, expressions, etc. that are used to replace source dialect strings) will be specific to the particular source and target SQL dialects, other aspects of the translation process (including those described with respect to FIG. 5B such as, for example, command translation, variable resolution, DML creation, etc.) apply generally across numerous source and target SQL dialects.

At act 524, one or more commands in the SSD statement may be translated from the source SQL dialect to the target SQL dialect. This may be performed, for example, when the same underlying command is called by different names in the dialects. As another example, one command may be translated to a different type of command, but one that suffices for purposes of the functionality intended to be performed by the SSD statement.

An example of translation is shown in FIGS. 7A and 7B. FIG. 7A shows a portion of a HQL dialect script 700 part of an HQL application and FIG. 7B shows a portion of a PostgreSQL script 750 obtained by translating the HQL dialect script shown in FIG. 7A, in accordance with some embodiments of the technology described herein. As can be seen in this example, the “INSERT OVERWRITE” command 702 in dialect script is translated, at act 524, to the “INSERT INTO” command 752. In addition, the source metadata 706 shown in FIG. 7A has been commented (e.g., during the preprocessing step 520 described above) and may be removed subsequently.

At act 526, one or more types, functions, and/or other expressions of the SSD statement may be translated from the source SQL dialect to the target SQL dialect. For example, certain variable types in the source SQL dialect may be replaced with appropriate variable types in the target SQL dialect. For example, in translating from HQL to PostgreSQL, “STRING” may be replaced with “TEXT” and “tinyint” may be replaced with “smallint”. As another example, an array definition may be translated to type “char”. As yet another example, a common expression, such as “current_timestamp( )” may be translated to “current timestamp”.

At act 528, at least some of the variables present in the SSD statement may be resolved. An SSD statement may include one or more environment variables and/or one or more bind variables. An environment variable may be a reference to a schema or a dataset (e.g., a table). A bind variable may be any other variable that is assigned a value that is not a reference. For example, a bind variable may be a variable being assigned a value such as a number, a string, or a date.

In some embodiments, at act 528, the environment variables may be resolved (i.e., values may be assigned to these variables). For example, as shown in FIGS. 7A and 7B, the file system reference “‘${FileSystem_Path}/Directory_A/’” 704 is resolved to “filesystem_path/Directory_A/” 754, and the database name reference ${Database_Name} 708 part of “${Database_Name}.TABLE_1” is resolved to “database_name” as part of “database_name.TABLE_1” 758. Optionally, after the TSD statement resulting from the translation is converted to a corresponding dataflow graph, the resolved environment variables may be re-parameterized and can be variables in the generated dataflow graph (e.g., to then be resolved at runtime during execution by the graph execution engine 580).

On the other hand, in some embodiments, the bind variables may not be resolved as part of the translation and, instead, are maintained as variables. For example, as shown in FIGS. 7A and 7B, the bind variables 710 and 712, representing a start date and an end date, respectively, are not translated and appear as bind variables 760 and 762 in target dialect script 750.

At act 530, a data manipulation language (DML) definition for a table reference in the selected SSD statement may need to be obtained. For example, if no CREATE statement is available for a table, a DML definition for the table may be obtained at act 530. In some embodiments, the DML definition may be created manually (e.g., when the table contains a small number of fields and types can be inferred from insert statements). In some embodiments, the DML definition may be created automatically. For example, the DML definition may be inferred from other statements that reference the table. As one example, the DML definition may be automatically inferred from an insert statement. As another example, when a LOAD statement has the same DML definition for a data sink and a data source, if the DML definition for the data sink is available, it can be copied for the data source, and vice versa.

In some embodiments, as already mentioned with reference to act 504 of process 500, act 525 may be implemented by executing translation scripts that were automatically generated during analysis of the SSD scripts (e.g., during act 504). On the other hand, in other embodiments, act 525 may be implemented in software without a priori generation of translation scripts, as aspects of the technology described herein are not limited in this respect.

It should be appreciated that process 550 is illustrative and that there are variations. For example, as shown in FIG. 5B, the SSD statements are converted serially, one after the other. However, in other embodiments, two or more or all of the SSD statements, part of the SSD script obtained at act 506, may be converted in parallel, as aspects of the technology described herein are not limited in this respect.

### Dataflow Graph Optimization

As described herein, in some embodiments, one or more optimizations may be applied to dataflow graphs to obtain respective optimized graphs that are more computationally efficient to execute. For example, a dataflow graph may: (1) include nodes that represent redundant data processing operations; (2) require performing data processing operations whose results are subsequently unused: (3) require unnecessarily performing serial processing in cases where parallel processing is possible; (4) apply a data processing operation to more data than needed in order to obtain a desired result; (5) break out computations over multiple nodes, which significantly increases the computational cost of performing the computations in situations where the data processing for each dataflow graph node is performed by a dedicated thread in a computer program, a dedicated computer program (e.g., a process in an operating system), or a dedicated computing device; (6) require performing a stronger type of data processing operation that requires more computation (e.g., a sort operation, a rollup operation, etc.) when a weaker type of data processing operation that requires less computation (e.g., a sort-within-groups operation, a rollup-within-groups operation, etc.) will suffice; (7) require the duplication of processing efforts; or (8) not include operations or other transformations that are useful or required for processing data, or combinations of them, among others.

Accordingly, in some embodiments, one or more optimizations may be applied (e.g., by software part of graph optimization module 565) to a dataflow graph to improve the computational efficiency of processing data in accordance with the data processing operations specified by the dataflow graph relative to processing the same data without the optimizations. Examples of optimizations include, but are not limited to, removing one or more redundant data processing operations, removing one or more unreferenced data processing operations, performing one or more strength reduction optimizations, moving filtering steps earlier in the data flow (e.g., by moving one or more nodes corresponding to the filtering components), performing one or more combining operations optimizations, performing one or more width reduction optimizations, and/or performing one or more deduplication optimizations.

For example, an optimization may involve removing redundancy by removing at least one node representing a data processing operation determined to be redundant. In some embodiments, optimizing a dataflow graph by removing redundancy may involve: (1) identifying two adjacent nodes in the dataflow graph representing respective data processing operations, with the second data processing operation duplicating or nullifying the effect of the first data processing operation such that one of the two data processing operations is redundant; and (2) optimizing the dataflow graph by removing the node(s) representing redundant operations (e.g., the nodes representing the duplicated or nullified operations). For example, two adjacent nodes representing the same data processing operation (e.g., sorting with respect to the same key) may be identified. Having adjacent nodes performing the same data processing operation may be redundant, and one of the two adjacent nodes may be removed. As another example, two adjacent nodes may be identified with the first node representing a repartition operation (which partitions data for parallel processing on different computing devices) followed by node representing the serialize operation (which operates to combine all the data for serial processing by a single computing device). Since the effect of repartitioning will be nullified by the subsequent serialize operation, it is not necessary to perform the repartitioning operation (e.g., the repartitioning operation is redundant), and the repartitioning operation can be removed as part of the optimization.

As another example, in some embodiments, optimizing a dataflow graph may involve identifying a first node representing a first operation that commutes with one or more other nodes representing other operations. If the first node commutes with the one or more other nodes, then the dataflow graph may be updated by changing the order of the first node with at least one of the one or more other nodes (e.g., by rearranging the order of the nodes). In this way, the dataflow graph operation may be optimizing by ordering the nodes and corresponding operations in a way that improves processing efficiency, speed, or otherwise optimizes processing by the dataflow graph without changing the overall result. In addition, commuting nodes the dataflow graph nodes facilitates application of one or more other optimizations. For example, suppose that the first node represents sorting with respect to particular key and changing the order of the first node with one or more other nodes results in placing the first node adjacent to a second node representing also representing a second sort operation on the particular key or another key. In this case, the second sort operation is either redundant (when sorting on the same particular key) or renders the first sort operation irrelevant (when sorting on a different key, the sorted order produced by the first sort operation will be overwritten). In this example, a node representing either the first sort operation or the second sort operation may be removed.

As another example, an optimization may involve removing at least one node representing a data processing operation determined to be unused, unreferenced, or otherwise unnecessary operations. For example, a node representing a sort operation may be identified as being unnecessary because the order resulting from the sorting operation is not needed or relied upon in subsequent processing. Nodes representing such operations may be removed.

As another example, an optimization may involve performing a strength reduction transformation on one or more nodes. Performing a strength reduction optimization may involve replacing (in the dataflow graph being optimized) a first node representing a first data processing operation (e.g., a node representing a sort data processing operation) with a second node representing a second data processing operation of a weaker type that the first data processing operation (e.g., a node representing a sort-within-groups data processing operation).

As another example, an optimization may involve combining two or more nodes in the graph being analyzed. For example, the optimization may involve identifying dataflow graph nodes representing different operations that may be combined (e.g., combining two adjacent nodes representing filtering operations on different keys with a filtering operation that filters simultaneously on both keys, combining two adjacent nodes representing two join operations into a single node representing a join operation). During execution of a dataflow graph, data processing operations represented by separate nodes may be executed by different processes running on one or multiple computing devices. Combining the separate nodes and their respective operations into a single node so that all of the operations are performed by a single process executing on a single computing device reduces the overhead of inter-process (and potentially inter-device) communication.

As another example, an optimization may involve applying a serial to parallel transformation to the dataflow graph, which breaks one or more of the several operations into separate nodes for parallel processing (e.g., an automatic parallelism operation). The operations may then execute in parallel using different processes running on one or multiple computing devices. A merge operation may be added to the dataflow graph to merge the result of the parallel operations. For example, an optimization may involve identifying points in the dataflow graph containing large chunks of data (e.g., data corresponding to large tables and indices), and performing a partitioning transformation of the dataflow graph to break the data into smaller partitions (e.g., an automatic partitioning operation). The partitions may then be processed in series or parallel (e.g., by combining the automatic partitioning operation with the automatic parallelism operation). By reducing the size of the data to be processed or by separating operations for parallel processing, or both, such optimizations can significantly improve the efficiency of the transformed dataflow graph.

In some embodiments, data in a data source (e.g., a data table) may already be partitioned. For example, a data table may be partitioned into multiple data tables of smaller size. In some embodiments, the partitions of a data source may be referenced by values of a partition key. In some embodiments, a specification of a partition key with respect to a data source may be used as input for converting an SSD application program to one or more dataflow graphs. The specification of a partition key with respect to a data source may obviate the need to partition the data source. The conversion process may thus bypass a step of partitioning the data (e.g., as part of parallelizing operations in the SSD application program). Instead, the partition key may be used to operate on partitions of the data source (e.g., in parallel). The partition key may be used to access each partition and perform operations using the partition.

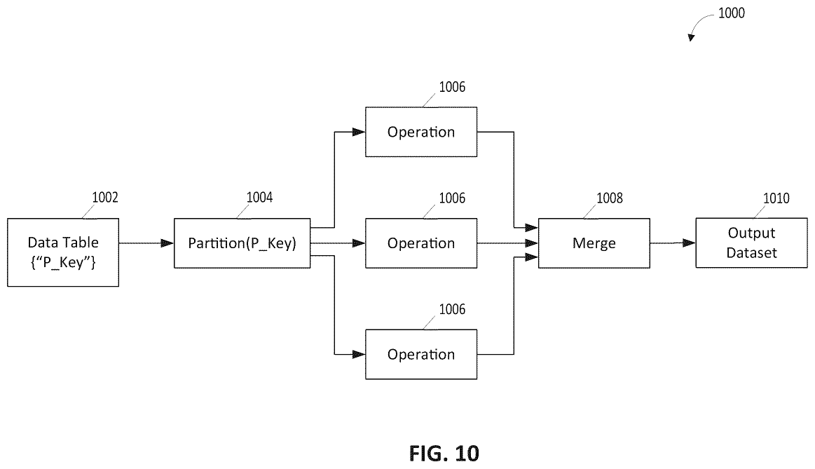

In some embodiments, the specification of a partition key with respect to a data source may be used as input for converting an SSD application program to dataflow graph(s) (e.g., as input used in performing process 500 described herein with reference to FIG. 5A and/or process 550 described herein with reference to FIG. 5B). For example, the specification of the partition key may be a property of the data source (e.g., a data table) that is set prior to initiating conversion of an SSD application program that reads data from the data source. During conversion of the SSD application program, a dataflow graph generated from the SSD application program may use the partition key (e.g., to parallelize operations on data read from the data source). FIG. 10 shows an example dataflow graph 1000 in which a source data table 1002 is a partitioned table based on the partition key “P_Key”. The partition key of the data table 1002 may be specified as a property of the data table 1002. Accordingly, the dataflow graph 1000 generated from an SSD application program operates on partitions of the data (e.g., partitioned data tables) using the partition key “P_Key”. The dataflow graph 1000 performs an operation 1006 on each partition in parallel. The result of the operation 1006 performed on each partition is input to an operation 1008 to merge the results. The merged results are written to an output dataset 1010.

In some embodiments, an optimization may involve performing a width-reduction optimization. Applying this optimization may involve identifying data (e.g., one or more columns of data) to be deleted at a certain point in the dataflow graph prior to the performance of subsequent operations because that data (e.g., the data to be deleted) is not used in subsequent operations and need not be propagated as part of the processing. As another example, a node in a dataflow graph may be configured to perform several operations, and the results of some of these operations may be unused. In this example, a width reduction transformation may be used to remove the unused or otherwise unnecessary data (e.g., by inserting a node to delete the data at the identified point, by replacing a node configured to perform several operations with another node configured to perform only those operations whose results are used, etc.). In this way, fewer computational resources are needed by the dataflow graph to carry data through subsequent operations (e.g., by reducing network, memory, and processing resources utilized).

In some embodiments, to identify portions of the dataflow graph being optimized to which to apply one or more optimizations, a dataflow graph pattern matching language may be employed. The dataflow subgraph pattern matching language may include one or more expressions for identifying specific types of subgraphs in the dataflow graph. A particular expression may facilitate identifying one or more portions for the application of a specific optimization rule or multiple optimization rules.

For example, the pattern matching language may include expressions for identifying a series of nodes of at least a threshold length (e.g., at least two, three, four, five, etc.) representing a respective series of calculations that could be combined and represented by a single node in the graph using a combining operations optimization rule. Identifying such patterns may facilitate the application of the optimization in which operations are combined. A non-limiting example of one such expression is “A→B→C→D”, which may help to identify a series of four consecutive data processing operations which may be combined.

As another example, the pattern matching language may include expressions for identifying portions of the dataflow graph in which certain types of nodes can commute with other nodes. This may facilitate the application of multiple different types of optimization rules to the dataflow graph. When a data processing system (e.g., system 552 using graph optimization module 565) determines that the order of one or more nodes in the dataflow graph may be altered without changing the processing results, this allows the data processing system to consider changes to the structure of the dataflow graph (as allowed by the degree of freedom available through commuting operations) in order to identify portions to which optimization rules could be applied. As a result of considering commuting-based alterations, one or more optimization rules may become applicable to a portion of a graph to which the rule(s) were otherwise not applicable.

For example, an optimization rule may involve identifying two adjacent nodes in the dataflow graph representing respective sort operations, with the second sort operation nullifying the effect of the first operation such that the first operation should be dropped. By definition, such an optimization rule would not be applied to a dataflow graph that does not have adjacent nodes representing sort operations. However, if a first node representing a first sort operation were to commute with one or more other nodes, then it may be possible to change the order of the first node with at least one of the one or more other nodes such that the first node representing the first sort operation is placed adjacent to a second node representing a second sort operation. As a result of commuting nodes in this way, the optimization rule that removes the redundant first sort operation may be applied to the dataflow graph.

Accordingly, in some embodiments, the subgraph matching language may include one or more expressions for identifying subgraphs of a dataflow graph in situations where the order nodes in the dataflow graph may be changed. As one example, the expression “A→( . . . )→B” (where each of A and B may be any suitable data processing operation such as a sort, a merge, etc.) may be used to find a portion of the dataflow graph having a node “A” (i.e., a node representing the operation “A”) and node B (representing operation B), and one or more nodes between the nodes A and B with which the node A commutes (e.g., if the order of the nodes is changed, the result of processing performed by these nodes does not change). If such a portion were identified, then the dataflow graph may be changed by moving node A adjacent to node B to obtain the portion “AB”. As a specific example, if a dataflow graph were to have the nodes ACDB, and the operation A were to commute with the operations C and D, then the dataflow graph may be altered to become “CDAB”. In turn, the data processing system may consider whether an optimization rule applies to the portion “AB.” For example, if the operation A were a sort and the operation B were a sort, the data processing system may attempt to determine whether these two sorts may be replaced with a single sort.

As another example, the expression “A→( . . . )→B*” may be used to find a portion of the dataflow graph having a node A, a second node B, and one or more nodes between these nodes with which the node B commutes. As a specific example, if a dataflow graph were to have the nodes ACDB, and the operation B were to commute with the operations C and D, then the dataflow graph may be altered to become “ABCD”. In turn, the data processing system may consider whether an optimization rule applies to the portion “AB.”

As another example, the expression “A→( . . . )→B**” may be used to find a portion of the dataflow graph having a node A, a node B, and one or more nodes (e.g., C and D) between the nodes A and B with which node B does not commute. In that case, the system may try to perform a “pushy” commute, where, if possible, the nodes C and D would be pushed to the left of the node A. As a specific example, if a dataflow graph were to have the nodes ACEDB, and the operation B were to commute with the operation E but not operations C and D, then the dataflow graph may be altered to become “CDABE”—B commuted with E, but pushed C and D to the left of A.

As yet another example, the expression “A**→( . . . )→B” may be used to find a portion of the dataflow graph having a node A, a node B, and one or more nodes (e.g., C and D) between the nodes A and B with which node A does not commute. In that case, the system may try to perform a “pushy” commute, where, if possible, the nodes C and D would be pushed to the right of the node B. As a specific example, if a dataflow graph were to have the nodes ACEDB, and the operation A were to commute with the operation E but not operations C and D, then the dataflow graph may be altered to become “EABCD”—node A commuted with E, but pushed C and D to the right of B.

It should be appreciated that the above-described examples of expressions of a subgraph matching language are illustrative. In some embodiments, one or more other expressions may be part of the subgraph matching language in addition to or instead of the above-described examples.

Various aspects are described herein including, but not limited to, the following aspects.

1. A method for converting application programs written in a source structured query language (SQL) dialect to respective computer programs embodied by dataflow graphs, the method comprising: using at least one computer hardware processor to perform: obtaining a source SQL dialect (SSD) application program comprising one or more SSD scripts, the one or more SSD scripts comprising a plurality of SSD statements; translating the plurality of SSD statements into a respective plurality of target SQL dialect (TSD) statements; converting the plurality of TSD statements into a respective plurality of dataflow graphs; and merging dataflow graphs in the plurality of dataflow graphs to obtain one or more merged dataflow graphs.

2. The method of aspect 1, wherein the one or more SSD scripts include a first SSD script and a second SSD script, the plurality of SSD statements includes a first plurality of SSD statements in the first SSD script and a second plurality of SSD statements in the second SSD script, and wherein: translating the plurality of SSD statements comprises: translating the first plurality of SSD statements into a first plurality of TSD statements in the plurality of TSD statements, and translating the second plurality of SSD statements to a second plurality of TSD statements in the plurality of TSD statements; and converting the plurality of TSD statements comprises: converting the first plurality of TSD statements into a first plurality of dataflow graphs in the plurality of dataflow graphs, and converting the second plurality of TSD statements into a second plurality of dataflow graphs in the plurality of dataflow graphs.

3. The method of aspect 2, wherein merging dataflow graphs in the plurality of dataflow graphs comprises: merging the first plurality of dataflow graphs and the second plurality of dataflow graphs into a single merged dataflow graph.

4. The method of aspect 2, wherein merging dataflow graphs in the plurality of dataflow graphs comprises: merging the first plurality of dataflow graphs into a first merged dataflow graph, and merging the second plurality of dataflow graphs into a second merged dataflow graph different from the first merged dataflow graph.

5. The method of any one of aspects 1-4, wherein the one or more SSD scripts include multiple SSD scripts, the plurality of SSD statements includes a respective set of SSD statements in each of the multiple SSD scripts, wherein translating the plurality of SSD statements comprises translating each of the respective sets of SSD statements into respective sets of TSD statements in the plurality of TSD statements, and wherein converting the plurality of TSD statements comprises converting each of the respective sets of TSD statements into a respective set of dataflow graphs in the plurality of dataflow graphs.

6. The method of aspect 5, wherein merging dataflow graphs in the plurality of dataflow graphs comprises merging dataflow graphs across multiple or all of the respective sets of dataflow graphs into a single merged dataflow graph.

7. The method of aspect 5, wherein merging dataflow graphs in the plurality of dataflow graphs comprises merging dataflow graphs in each of the respective sets of dataflow graphs into a respective merged dataflow graph thereby obtaining a plurality of merged dataflow graphs.

8. The method of any one of aspects 1-7, further comprising: optimizing the one or more merged dataflow graphs to obtain one or more optimized merged dataflow graphs; and executing the one or more optimized merged dataflow graphs.

9. The method of any one of aspects 1-7, further comprising: executing the one or more merged dataflow graphs.

10. The method of aspect 8 or 9, wherein executing the one or more optimized merged dataflow graphs comprises assigning processing layouts to nodes in the one or more optimized merged dataflow graphs.

11. The method of any one of aspects 1-10, wherein the source SQL dialect is Hive Query Language (HQL), SNOWFLAKE SQL, Spark SQL, PySpark, DB2 SQL, or TERADATA SQL, BIGQUERY SQL.

12. The method of any one of aspects 1-11, wherein the target SQL dialect is ANSI-92 SQL or PostgreSQL.

13. The method of any one of aspects 1-12, wherein the source SQL dialect is Hive Query Language (HQL), wherein the SSD application program is an HQL application program comprising a plurality of HQL scripts, each of the plurality of HQL scripts comprising a plurality of HQL statements, and wherein the target SQL dialect is ANSI SQL or PostgreSQL.

14. The method of any one of aspects 1-13, wherein translating the plurality of SSD statements into the respective plurality of target SQL dialect (TSD) statements comprises: for each particular SSD statement in the plurality of SSD statements, performing one or more of: translating a command in the particular SSD statement to a corresponding command in the target SQL dialect; translating a type or a function in the particular SSD statement to corresponding type or function in the target SQL dialect; resolving one or more variables in the SSD particular statement; and obtaining a data manipulation language (DML) definition for a table referenced in the particular SSD statement.

15. The method of any one of aspects 1-14, wherein the plurality of TSD statements comprises a first TSD statement, wherein converting the plurality of TSD statements into the respective plurality of dataflow graphs comprises converting the first TSD statement into a first dataflow graph of the respective plurality of dataflow graphs, and wherein converting the first TSD statement into the first dataflow graph comprises: generating a query plan from the first TSD statement, wherein the query plan identifies one or more data processing operations to be performed if the TSD statement were executed, and generating the first dataflow graph from the query plan, wherein the first dataflow graph includes a node for each of at least some of the one or more data processing operations identified in the query plan.

16. The method of any one of aspects 1-15, wherein the plurality of dataflow graphs includes: a first dataflow graph configured to write out a particular dataset, a second dataflow graph configured to read in the particular dataset, and wherein merging the dataflow graphs comprises: configuring, as part of a merged dataflow graph, the second dataflow graph to receive the particular dataset from the first dataflow graph.

17. The method of aspect 16, wherein the first dataflow graph has a first output node representing a data processing operation for writing data to the particular dataset, wherein the second dataflow graph has a second input node representing a data processing operation for reading data from the particular dataset, wherein the configuring comprises adding an edge from the first output node to the second input node, the edge representing flow of data from the first dataflow graph to the second dataflow graph.

18. The method of any one of aspects 1-17, wherein merging the plurality of dataflow graphs comprises: identifying one or more input datasets that at least one dataflow graph of the plurality of dataflow graphs is configured to read in; identifying one or more output datasets that one or more dataflow graphs of the plurality of dataflow graphs is configured to write out; comparing the one or more input datasets and the one or more output datasets; determining, based on results of the comparing, that a first dataflow graph in a pair of dataflow graphs, among the plurality of dataflow graphs, is configured to write out a particular output dataset of the one or more output datasets and a second dataflow graph in the pair of dataflow graphs is configured to read in the particular output dataset; and introducing, as part of one of the one or more merged dataflow graphs, an edge representing a flow of data from the first dataflow graph to the second dataflow graph.

19. The method of any one of aspects 1-18, wherein the one or more SSD scripts of the source SQL dialect (SSD) application program are multiple SSD scripts and the source SQL dialect (SSD) application program further includes a source SQL dialect script orchestration logic that is configured to control a sequence in which the multiple SSD scripts are to execute in accordance with dependencies among the multiple SSD scripts, the method further including: converting the SSD script orchestration logic to a control flow plan that is configured to control execution of the one or more merged dataflow graphs.

20. The method of aspect 19, wherein the control flow graph is configured to cause the one or more merged dataflow graphs to execute in a particular sequence such that execution of a certain one of the one or more merged dataflow graphs is to complete before execution of another one of the one or more merged dataflow graphs begins.

21. The method of aspect 20, wherein the particular sequence is in accordance with the dependencies among the multiple SSD scripts.

22. The method of any one of aspects 19 to 21, wherein the control flow plan is embodied by a control flow graph, which is executable.

23. The method of any one of aspects 19 to 22, wherein a first one of the one or more merged dataflow graphs is based on a first SSD script that, when executed, generates results that are used by a second SSD script, wherein a second one of the one or more merged dataflow graphs is based on the second SSD script.

24. The method of any one of aspects 19 to 23, wherein the orchestration logic requires that certain SSD scripts of the multiple SSD scripts execute serially and/or allow that certain SSD scripts of the multiple SSD scripts execute in parallel.

25. The method of any one aspects 1-24, wherein each of the SSD scripts is configured to read data from and/or write data to one or more database systems in an SSD environment via a query language interface.

26. The method of aspect 25, wherein, during execution of the one or more merged dataflow graphs, one or more of the merged dataflow graphs is configured to read data from and/or write data to one or more data stores.

27. The method of aspect 26, wherein the one or more data stores are located in a computing environment external to the SSD environment.

28. The method of aspect 27, wherein the computing environment includes the computer hardware processor and the one or more data stores.

29. The method of aspect 26, 27 or 28, wherein the one or more data stores store data obtained from the one or more database systems.

30. The method of aspect 25, wherein the computer hardware processor is part of a computing environment that is configured to communicate with the one or more database systems via a communication link to access the data stored in the one or more database systems during execution of the one or more merged dataflow graphs.

31. The method of any one of aspects 1-30, wherein the translating of the plurality of SSD statements into the plurality of target SQL dialect (TSD) statements includes: analyzing the SSD application program to identify information to be used for the translating of the plurality of SSD statements.

32. The method of aspect 31, wherein the analyzing includes parsing the plurality of SSD scripts of the SSD application program and identifying, within each SSD script. SSD statements that are to be translated from the SSD to the target SQL dialect.

33. The method of aspect 32, for each identified SSD statement, the analyzing includes identifying one or more SSD statement components and determining whether the one or more SSD statement components are to be translated from the SSD to the TSD and/or whether any action of a set of actions is to be performed for translation of an SSD statement into a TSD statement and/or converting a TSD statements into a dataflow graph, the set of actions including changing a command name, resolving a variable, and/or changing a type definition.

34. The method of aspect 31, 32 or 33, wherein the analyzing includes generating, based on results of the analysis performed, one or more translation scripts that are configured to translate SSD statements in the SSD application to corresponding TSD statements that are suitable for subsequent conversion into dataflow graphs.

35. The method of aspect 34, wherein the translating of the plurality of SSD statements into the plurality of target SQL dialect (TSD) statements includes: executing the one or more translation scripts to translate the SSD statements in the SSD application to the corresponding TSD statements that are suitable for subsequent conversion into dataflow graphs.

36. The method of any one of aspects 31 to 35, wherein the analyzing includes identifying portions of the SSD scripts that are not required to be translated.

37. The method of aspect 36, wherein the analyzing includes marking the identified portions for removal.

38. The method of aspect 36, wherein the analyzing includes generating translation scripts that, when executed, mark the identified portions for subsequent removal and/or remove the identified portions.

39. The method of any one of aspects 31 to 38, wherein the analyzing includes identifying commands in the SSD statements and determining whether the commands are to be translated from the source to the target SQL dialect.

40. The method of aspect 39, wherein a command in the SSD statements is to be translated into a command that is supported by the TSD by determining that the command in the SSD statements does not exist in the TSD.

41. The method of any one of aspects 31 to 40, wherein the analyzing includes: identifying variables in the plurality of SSD statements of the SSD application program; identifying values to which the variables are to be resolved during the translating; and generating translation scripts that are configured to resolve the variables to the identified values.

42. The method of any one of aspects 1-41, wherein the translating a particular SSD statement of the plurality of SSD statements into a corresponding TSD statement includes performing one or more of: (a) translating a command in the particular SSD statement to a corresponding command in the TSD: (b) translating a type, a function, or other type of expression in the particular SSD statement to corresponding type, function, or expression in the TSD; (c) resolving one or more variables in the particular SSD statement; and/or (d) obtaining a data manipulation language (DML) definition for a table referenced in the particular SSD statement.

43. The method of any one of aspects 15 to 42, wherein the one or more data processing operations comprise multiple data processing operations the generated query plan further specifies an order in which the data processing operations are to be performed if the TSD statement were executed.

44. The method of aspect 43, wherein the query plan indicates that a first one of the data processing operations is to be executed before a second one of the data processing operations and generating the first dataflow graph from the query plan comprises generating the first dataflow graph to include: a first node representing the first data processing operation and a second node representing the second data processing operation; and a link or edge specifying a dataflow path from the first node to the second node.

45. The method of any one of aspects 15 to 44, wherein the first dataflow graph generated from the query plan is different from the query plan, wherein: the first dataflow graph is executable by a graph execution engine for execution of the TSD statement; and the query plan is not executable by the graph execution engine.

46. The method of any one of aspects 1-45, wherein a merged dataflow graph of the one or more merged dataflow graphs is obtained by iteratively merging in dataflow graphs of the plurality of dataflow graphs to obtain the merged dataflow graph.

47. The method of any one of aspects 1-46, wherein the merging comprises: after the plurality of TSD statements have been converted into the respective plurality of dataflow graphs, obtaining the one or more merged dataflow graphs by: introducing a first dataflow graph of the plurality of dataflow graphs as a merged dataflow graph; and iteratively stitching dataflow graphs of the plurality of dataflow graphs into the merged dataflow graph one at a time.

48. The method of any one of aspects 1-47, wherein the SSD application program is hosted in a first computing environment and the one or more merged dataflow graphs are hosted in a second computing environment that is different from the first computing environment.

49. The method of aspect 48, wherein the second computing environment is external and/or remote from the first computing environment.

50. A system for converting application programs written in a source structured query language (SQL) dialect to respective computer programs embodied by dataflow graphs, the system comprising: at least one computer hardware processor; at least one non-transitory computer-readable storage medium storing processor-executable instructions that, when executed by the at least one computer hardware processor, causes the at least one computer hardware processor to perform the method of any one of aspects 1-49.

51. At least one non-transitory computer-readable storage medium storing processor-executable instructions that, when executed by at least one computer hardware processor, causes the at least one computer hardware processor to perform the method of any one of aspects 1-49.

52. A method for converting application programs written in a source structured query language (SQL) dialect to respective computer programs embodied by dataflow graphs, the method comprising: at least one computer hardware processor; at least one non-transitory computer-readable storage medium storing processor-executable instructions that, when executed by the at least one computer hardware processor, causes the at least one computer hardware processor to perform: obtaining a source SQL dialect (SSD) application program comprising one or more SSD scripts, the one or more SSD scripts comprising a plurality of SSD statements; translating the plurality of SSD statements into a respective plurality of target SQL dialect (TSD) statements; converting the plurality of TSD statements into a respective plurality of dataflow graphs; and executing the respective plurality of dataflow graphs.

53. The method of aspect 52, wherein the executing comprises: optimizing the plurality of dataflow graphs to obtain an optimized plurality of dataflow graphs; and executing the optimized plurality of dataflow graphs.

54. The method of aspect 52, further comprising: merging the respective plurality of dataflow graphs to obtain one or more merged dataflow graphs, wherein the executing comprises executing the one or more merged dataflow graphs.

55. The method of aspect 52, further comprising: merging the respective plurality of dataflow graphs to obtain one or more merged dataflow graphs, wherein the executing comprises: optimizing the one or more merged dataflow graphs to obtain one or more optimized dataflow graphs; and executing the one or more optimized dataflow graphs.

56. A system, comprising: at least one computer hardware processor; and at least one non-transitory computer-readable storage medium storing processor-executable instructions that, when executed by the at least one computer hardware processor, causes the at least one computer hardware processor to perform the method of any one of aspects 51-55.

57. At least one non-transitory computer-readable storage medium storing processor-executable instructions that, when executed by at least one computer hardware processor, causes the at least one computer hardware processor to perform the method of any one of aspects 51-55.

58. A method for executing a computer program embodied by a plurality of dataflow graphs, the method comprising: using at least one computer hardware processor to perform: obtaining a plurality of dataflow graphs representing different portions of the computer program, each of the plurality of graphs configured to read at least one input dataset and configured to write at least one output dataset; merging dataflow graphs in the plurality of dataflow graphs to obtain one or more merged dataflow graphs; and executing the one or more merged dataflow graphs.

59. The method of aspect 58, further comprising: optimizing the one or more merged dataflow graphs to obtain one or more optimized dataflow graphs, wherein the executing comprises executing the one or more optimized dataflow graphs.

60. The method of aspect 58, where obtaining the plurality of dataflow graphs comprises: obtaining a source SQL dialect (SSD) application program comprising one or more SSD scripts, the one or more SSD scripts comprising a plurality of SSD statements: translating the plurality of SSD statements into a respective plurality of target SQL dialect (TSD) statements; and converting the plurality of TSD statements into the plurality of dataflow graphs.

61. A system for executing of a computer program embodied by a plurality of dataflow graphs, the system comprising: at least one computer hardware processor; and at least one non-transitory computer readable storage medium storing processor executable instructions that, when executed by the at least one computer hardware processor, cause the at least one computer hardware processor to perform the method of any one of aspects 58-60.

62. At least one non-transitory computer readable storage medium storing processor executable instructions that, when executed by at least one computer hardware processor, cause the at least one computer hardware processor to perform the method of any one of aspects 58-60.

### Example Computer System

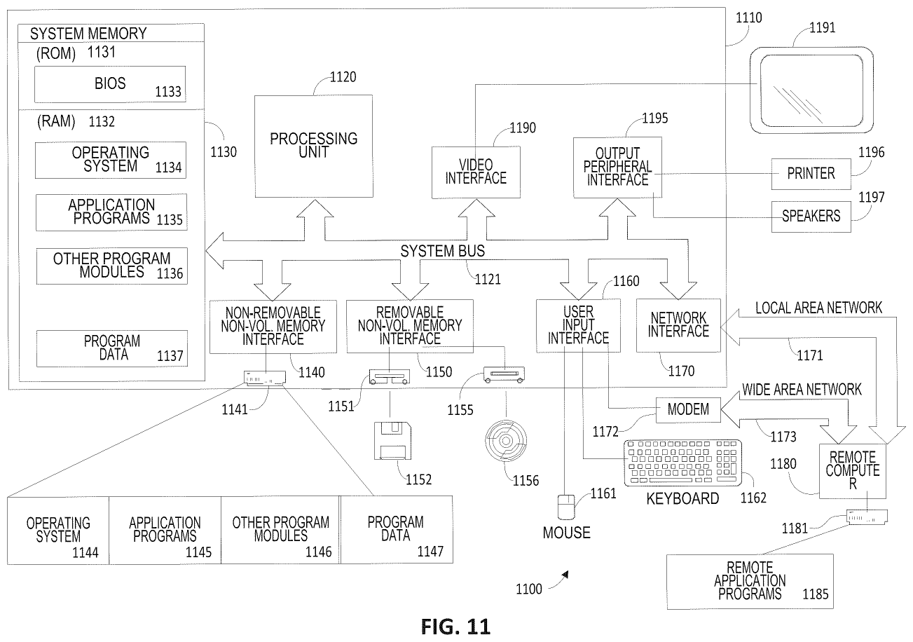

FIG. 11 illustrates an example of a suitable computing system environment 1100 on which the technology described herein may be implemented. The computing system environment 1100 is only one example of a suitable computing environment and is not intended to suggest any limitation as to the scope of use or functionality of the technology described herein. Neither should the computing environment 1100 be interpreted as having any dependency or requirement relating to any one or combination of components illustrated in the exemplary operating environment 1100.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 11, an exemplary system for implementing the technology described herein includes a general purpose computing device in the form of a computer 1100. Components of computer 1110 may include, but are not limited to, a processing unit 1120, a system memory 1130, and a system bus 1121 that couples various system components including the system memory to the processing unit 1120. The system bus 1121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (ELISA) bus, Video Electronics Standards Association (VESA) local bus, and Peripheral Component Interconnect (PCI) bus also known as Mezzanine bus.

Computer 1110 typically includes a variety of computer readable media. Computer readable media can be any available media that can be accessed by computer 1110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 1110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1130 includes computer storage media in the form of volatile and/or nonvolatile memory such as read only memory (ROM) 1131 and random access memory (RAM) 1132. A basic input/output system 1133 (BIOS), containing the basic routines that help to transfer information between elements within computer 1110, such as during start-up, is typically stored in ROM 1131. RAM 1132 typically contains data and/or program modules that are immediately accessible to and/or presently being operated on by processing unit 1120. By way of example, and not limitation, FIG. 11 illustrates operating system 1134, application programs 1135, other program modules 1136, and program data 1137.

The computer 1110 may also include other removable/non-removable, volatile/nonvolatile computer storage media. By way of example only, FIG. 11 illustrates a hard disk drive 1141 that reads from or writes to non-removable, nonvolatile magnetic media, a flash drive 1151 that reads from or writes to a removable, nonvolatile memory 1152 such as flash memory, and an optical disk drive 1155 that reads from or writes to a removable, nonvolatile optical disk 1156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1141 is typically connected to the system bus 1121 through a non-removable memory interface such as interface 1140, and magnetic disk drive 1151 and optical disk drive 1155 are typically connected to the system bus 1121 by a removable memory interface, such as interface 1150.

The drives and their associated computer storage media described above and illustrated in FIG. 11, provide storage of computer readable instructions, data structures, program modules and other data for the computer 1110. In FIG. 11, for example, hard disk drive 1141 is illustrated as storing operating system 1144, application programs 1145, other program modules 1146, and program data 1147. Note that these components can either be the same as or different from operating system 1134, application programs 1135, other program modules 1136, and program data 1137. Operating system 1144, application programs 1145, other program modules 1146, and program data 1147 are given different numbers here to illustrate that, at a minimum, they are different copies. An actor may enter commands and information into the computer 1110 through input devices such as a keyboard 1162 and pointing device 1161, commonly referred to as a mouse, trackball or touch pad. Other input devices (not shown) may include a microphone, joystick, game pad, satellite dish, scanner, or the like. These and other input devices are often connected to the processing unit 1120 through a user input interface 1160 that is coupled to the system bus, but may be connected by other interface and bus structures, such as a parallel port, game port or a universal serial bus (USB). A monitor 1191 or other type of display device is also connected to the system bus 1121 via an interface, such as a video interface 1190. In addition to the monitor, computers may also include other peripheral output devices such as speakers 1197 and printer 1196, which may be connected through an output peripheral interface 1195.

The computer 1110 may operate in a networked environment using logical connections to one or more remote computers, such as a remote computer 1180. The remote computer 1180 may be a personal computer, a server, a router, a network PC, a peer device or other common network node, and typically includes many or all of the elements described above relative to the computer 1110, although only a memory storage device 1181 has been illustrated in FIG. 11. The logical connections depicted in FIG. 11 include a local area network (LAN) 1181 and a wide area network (WAN) 1183, but may also include other networks. Such networking environments are commonplace in offices, enterprise-wide computer networks, intranets and the Internet.

When used in a LAN networking environment, the computer 1110 is connected to the LAN 1181 through a network interface or adapter 1180. When used in a WAN networking environment, the computer 1110 typically includes a modem 1182 or other means for establishing communications over the WAN 1183, such as the Internet. The modem 1182, which may be internal or external, may be connected to the system bus 1121 via the actor input interface 1160, or other appropriate mechanism. In a networked environment, program modules depicted relative to the computer 1110, or portions thereof, may be stored in the remote memory storage device. By way of example, and not limitation, FIG. 11 illustrates remote application programs 1185 as residing on memory device 1181. It will be appreciated that the network connections shown are exemplary and other means of establishing a communications link between the computers may be used.

Having thus described several aspects of at least one embodiment of the technology described herein, it is to be appreciated that various alterations, modifications, and improvements will readily occur to those skilled in the art.

Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. The software code may be implemented in any suitable computing environment including, for example, a cloud computing environment. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined (e.g., the processes described herein in connection with FIGS. 5A and 5B) herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of computer- and/or processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion amongst a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the dataset fields with locations in a computer-readable medium that conveys relationship between the dataset fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 5A and 5B. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for converting application programs written in a source structured query language (SQL) dialect to respective computer programs embodied by dataflow graphs, the method comprising:
using at least one computer hardware processor to perform:
obtaining a source SQL dialect (SSD) application program comprising one or more SSD scripts, the one or more SSD scripts comprising a plurality of SSD statements;
translating the plurality of SSD statements into a respective plurality of target SQL dialect (TSD) statements;
converting the plurality of TSD statements into a respective plurality of dataflow graphs; and
merging dataflow graphs in the plurality of dataflow graphs to obtain one or more merged dataflow graphs.

2. The method of claim 1,
wherein the one or more SSD scripts include multiple SSD scripts, the plurality of SSD statements includes a respective set of SSD statements in each of the multiple SSD scripts,
wherein translating the plurality of SSD statements comprises translating each of the respective sets of SSD statements into respective sets of TSD statements in the plurality of TSD statements, and
wherein converting the plurality of TSD statements comprises converting each of the respective sets of TSD statements into a respective set of dataflow graphs in the plurality of dataflow graphs.

3. The method of claim 2, wherein merging dataflow graphs in the plurality of dataflow graphs comprises merging dataflow graphs across multiple or all of the respective sets of dataflow graphs into a single merged dataflow graph.

4. The method of claim 2, wherein merging dataflow graphs in the plurality of dataflow graphs comprises merging dataflow graphs in each of the respective sets of dataflow graphs into a respective merged dataflow graph thereby obtaining a plurality of merged dataflow graphs.

5. The method of claim 1, further comprising:
(a) optimizing the one or more merged dataflow graphs to obtain one or more optimized merged dataflow graphs, and executing the one or more optimized merged dataflow graphs; or
(b) executing the one or more merged dataflow graphs.

6. The method of claim 1,
wherein the source SQL dialect is Hive Query Language (HQL), SNOWFLAKE SQL, Spark SQL, PySpark, DB2 SQL, or TERADATA SQL, BIGQUERY SQL, and
wherein the target SQL dialect is ANSI-92 SQL or PostgreSQL.

7. The method of claim 1,
wherein the source SQL dialect is Hive Query Language (HQL),
wherein the SSD application program is an HQL application program comprising a plurality of HQL scripts, each of the plurality of HQL scripts comprising a plurality of HQL statements, and
wherein the target SQL dialect is ANSI SQL or PostgreSQL.

8. The method of claim 1, wherein translating the plurality of SSD statements into the respective plurality of target SQL dialect (TSD) statements comprises:
for each particular SSD statement in the plurality of SSD statements, performing one or more of:
translating a command in the particular SSD statement to a corresponding command in the target SQL dialect;
translating a type or a function in the particular SSD statement to corresponding type or function in the target SQL dialect;
resolving one or more variables in the SSD particular statement; and
obtaining a data manipulation language (DML) definition for a table referenced in the particular SSD statement.

9. The method of claim 1,
wherein the plurality of TSD statements comprises a first TSD statement,
wherein converting the plurality of TSD statements into the respective plurality of dataflow graphs comprises converting the first TSD statement into a first dataflow graph of the respective plurality of dataflow graphs, and
wherein converting the first TSD statement into the first dataflow graph comprises:
generating a query plan from the first TSD statement, wherein the query plan identifies one or more data processing operations to be performed if the TSD statement were executed, and
generating the first dataflow graph from the query plan, wherein the first dataflow graph includes a node for each of at least some of the one or more data processing operations identified in the query plan.

10. The method of claim 1, wherein merging the plurality of dataflow graphs comprises:
identifying one or more input datasets that at least one dataflow graph of the plurality of dataflow graphs is configured to read in;
identifying one or more output datasets that one or more dataflow graphs of the plurality of dataflow graphs is configured to write out;
comparing the one or more input datasets and the one or more output datasets;
determining, based on results of the comparing, that a first dataflow graph in a pair of dataflow graphs, among the plurality of dataflow graphs, is configured to write out a particular output dataset of the one or more output datasets and a second dataflow graph in the pair of dataflow graphs is configured to read in the particular output dataset; and
introducing, as part of one of the one or more merged dataflow graphs, an edge representing a flow of data from the first dataflow graph to the second dataflow graph.

11. The method of claim 1,
wherein each of the SSD scripts is configured to read data from and/or write data to one or more database systems in an SSD environment via a query language interface, and
wherein, during execution of the one or more merged dataflow graphs, one or more of the merged dataflow graphs is configured to read data from and/or write data to one or more data stores.

12. The method of claim 1, wherein the translating of the plurality of SSD statements into the plurality of target SQL dialect (TSD) statements includes:
analyzing the SSD application program to identify information to be used for the translating of the plurality of SSD statements,
wherein the analyzing includes parsing the plurality of SSD scripts of the SSD application program and identifying, within each SSD script, SSD statements that are to be translated from the SSD to the target SQL dialect,
wherein, for each identified SSD statement, the analyzing includes identifying one or more SSD statement components and determining whether the one or more SSD statement components are to be translated from the SSD to the TSD and/or whether any action of a set of actions is to be performed for translation of an SSD statement into a TSD statement and/or converting a TSD statements into a dataflow graph, the set of actions including changing a command name, resolving a variable, and/or changing a type definition.

13. The method of claim 12,
wherein the analyzing includes generating, based on results of the analysis performed, one or more translation scripts that are configured to translate SSD statements in the SSD application to corresponding TSD statements that are suitable for subsequent conversion into dataflow graphs, and
wherein the translating of the plurality of SSD statements into the plurality of target SQL dialect (TSD) statements includes executing the one or more translation scripts to translate the SSD statements in the SSD application to the corresponding TSD statements that are suitable for subsequent conversion into dataflow graphs.

14. The method of claim 1, wherein the translating a particular SSD statement of the plurality of SSD statements into a corresponding TSD statement includes performing one or more of: (a) translating a command in the particular SSD statement to a corresponding command in the TSD; (b) translating a type, a function, or other type of expression in the particular SSD statement to corresponding type, function, or expression in the TSD; (c) resolving one or more variables in the particular SSD statement; and/or (d) obtaining a data manipulation language (DML) definition for a table referenced in the particular SSD statement.

15. The method of claim 1, wherein a merged dataflow graph of the one or more merged dataflow graphs is obtained by iteratively merging in dataflow graphs of the plurality of dataflow graphs to obtain the merged dataflow graph.

16. The method of claim 1, wherein the merging comprises:
after the plurality of TSD statements have been converted into the respective plurality of dataflow graphs, obtaining the one or more merged dataflow graphs by:
introducing a first dataflow graph of the plurality of dataflow graphs as a merged dataflow graph; and
iteratively stitching dataflow graphs of the plurality of dataflow graphs into the merged dataflow graph one at a time.

17. The method of claim 1, wherein the SSD application program is hosted in a first computing environment and the one or more merged dataflow graphs are hosted in a second computing environment that is different from the first computing environment.

18. The method of claim 17, wherein the second computing environment is external and/or remote from the first computing environment.

19. A system for converting application programs written in a source structured query language (SQL) dialect to respective computer programs embodied by dataflow graphs, the system comprising:
at least one computer hardware processor;
at least one non-transitory computer-readable storage medium storing processor-executable instructions that, when executed by the at least one computer hardware processor, causes the at least one computer hardware processor to perform a method comprising:
obtaining a source SQL dialect (SSD) application program comprising one or more SSD scripts, the one or more SSD scripts comprising a plurality of SSD statements;
translating the plurality of SSD statements into a respective plurality of target SQL dialect (TSD) statements;
converting the plurality of TSD statements into a respective plurality of dataflow graphs; and
merging dataflow graphs in the plurality of dataflow graphs to obtain one or more merged dataflow graphs.

20. At least one non-transitory computer-readable storage medium storing processor-executable instructions that, when executed by at least one computer hardware processor, causes the at least one computer hardware processor to perform a method for converting application programs written in a source structured query language (SQL) dialect to respective computer programs embodied by dataflow graphs, the method comprising:
obtaining a source SQL dialect (SSD) application program comprising one or more SSD scripts, the one or more SSD scripts comprising a plurality of SSD statements;
translating the plurality of SSD statements into a respective plurality of target SQL dialect (TSD) statements;
converting the plurality of TSD statements into a respective plurality of dataflow graphs; and
merging dataflow graphs in the plurality of dataflow graphs to obtain one or more merged dataflow graphs.
